(19) United States
(12) Patent Application Publication
(10) Pub. No.: US 2017/0086219 A1
(43) Pub. Date: Mar. 23, 2017

(54) METHOD AND APPARATUS FOR TRANSMITTING UPLINK DATA IN A WIRELESS COMMUNICATION SYSTEM

(71) Applicant: LG ELECTRONICS INC., Seoul (KR)

(72) Inventors: Eunjong LEE, Seoul (KR); Jaehoon CHUNG, Seoul (KR); Genebeck HAHN, Seoul (KR); Jinmin KIM, Seoul (KR); Kukheon CHOI, Seoul (KR); Kwangseok NOH, Seoul (KR)

(73) Assignee: LG ELECTRONICS INC., Seoul (KR)

(21) Appl. No.: 15/312,560

(22) PCT Filed: Jan. 15, 2015
(86) PCT No.: PCT/KR2015/000416

§ 371 Date: Nov. 18, 2016

Related U.S. Application Data
(60) Provisional application No. 61/994,969, filed on May 18, 2014.

(51) Int. Cl. H04W 72/12; H04W 74/00; H04L 5/00

(52) U.S. Cl. CPC H04W 72/1278; H04L 5/0005; H04W 74/004; H04W 88/08

(57) ABSTRACT

A method for transmitting uplink (UL) data in a wireless communication system, the method performed by a UE according to the present invention comprises receiving physical uplink control channel (PUCCH) resources for transmission of a BSR message from a base station; transmitting a BSR message to the base station through the allocated PUCCH resources; receiving an UL grant for UL data transmission from the base station; and transmitting UL data to the base station through the received UL grant, where control information related to a structure of the PUCCH resources is received through allocation of the PUCCH resources.

### TECHNICAL FIELD

The present invention relates to a wireless communication system and more particularly, a method for a terminal to transmit uplink data to a base station and an apparatus supporting the method.

### BACKGROUND ART

Mobile communication systems have been developed to provide a voice service while ensuring mobility of users. The mobile communication system has evolved to provide a data service in addition to the voice service. These days, due to explosive growth of traffic, communication resources are easily running short. Also, since demand for higher speed services is great, needs for more advanced mobile communication systems are getting larger.

Requirements for the next-generation mobile communication system largely include accommodation of explosive data traffic, considerable increase of transmission rate for each user, accommodation of the significantly increased number of connected devices, very low end-to-end latency, and high energy efficiency. To meet the requirements, various technologies such as dual connectivity, massive multiple input multiple output (MIMO), in-band full duplex, non-orthogonal multiple access (NOMA), support for super-wideband communication, and device networking are being studied.

### DISCLOSURE

### Technical Problem

The present invention has been made in an effort to provide a new PUCCH format for transmitting a buffer status report (BSR) message to reduce a delay of UL data transmission caused during an UL resource allocation process.

Also, the present invention has been made in an effort to transmit control information related to a structure of a new PUCCH format for transmission of a BSR message.

Technical objects of the present invention are not limited to those objects described above; other technical objects not mentioned above can be clearly understood from what are described below by those skilled in the art to which the present invention belongs.

### Technical Solution

To achieve the technical object, in a method for transmitting uplink (UL) data in a wireless communication system, the method carried out by a mobile terminal according to the present invention comprises receiving physical uplink control channel (PUCCH) resources for transmission of a BSR message from a base station; transmitting a BSR message to the base station through the allocated PUCCH resources; receiving an UL grant for UL data transmission from the base station; and transmitting UL data to the base station through the received UL grant, where control information related to a structure of the PUCCH resources is received through allocation of the PUCCH resources.

The control information according to the present invention includes at least one of a BSR PUCCH resource setup field, a BSR PUCCH resource release field, a BSR PUCCH resource index field representing the index of a BSR PUCCH resource, and a BSR LogicalChIndex field representing a BSR PUCCH resource configuration field related to configuration of a BSR PUCCH resource or a logical channel index of the BSR PUCCH resource.

The PUCCH resources according to the present invention are characterized by a structure where an N symbol BSR message generated through BPSK (Binary Phase Shift Keying) or QPSK (Quadrature Phase Shift Keying) modulation is transmitted repeatedly through 2 slots of one subframe or transmitted only once through one subframe.

The N symbol BSR message according to the present invention is mapped to the PUCCH resources by being spread in the frequency domain through a CAZAC (CZ) sequence of length M and/or in the time domain through an orthogonal cover (OC) sequence of length L; carrying out IFFT (Inverse Fast Fourier Transform); and being mapped to remaining symbols except for a reference signal (RS) symbol within one slot or one subframe.

The number of RS symbols according to the present invention is 3, 2, or 1 within one slot; and the number of remaining symbols is 4, 5, or 6 within one slot.

The length (M) of the CZ sequence according to the present invention is determined according to the number (N) of symbols of a BSR message generated through the BPSK or the QPSK modulation.

The number of BSR messages that can be distinguished from each other through the PUCCH resources according to the present invention is determined by the CZ sequence of length M and/or the orthogonal cover sequence of length L.

The number of BSR messages that can be distinguished from each other through the PUCCH resources according to the present invention is M*L.

The N value according to the present invention is 3, 6, 12, 48, 96, 192, 36, 72, 144, or 288.

The M value according to the present invention is 0, 2, 3, 4, 5, 6, 8, 10, 12, 16, 20, 24, 40 or 48.

The L value according to the present invention is 0, 2, 3, 4, 5, 6, 8, or 10.

The control information according to the present invention is transmitted through a cell entry process or an RRC connection reconfiguration process.

The present invention further comprises transmitting a scheduling request to the base station, where the SR is transmitted together with the BSR message.

A mobile terminal for transmitting uplink data in a wireless communication system comprises a radio frequency (RF) unit for transmitting and receiving a radio signal; and a processor, where the processor is controlled to receive from a base station control information related to configuration of physical uplink control channel (PUCCH) resources for BSR transmission; to transmit a BSR message to the base station through the PUCCH resources on the basis of the received control information; to receive an UL grant for UL data transmission from the base station; and to transmit UL data to the base station through the received UL grant.

### Advantageous Effects

The present invention defines a new PUCCH format for BSR transmission so that a mobile terminal required for UL data transmission can transmit UL data a lot faster as the mobile terminal makes a transition from a DRX mode to an active mode.

The present invention transmits a BSR message through a PUCCH format. Thus the present invention is enabled to directly receive an UL grant with respect to the data to actually transmit by transmitting the BSR message directly to a base station through BSR PUCCH resources allocated beforehand when a mobile terminal is required to transmit UL data

The advantageous effects that can be obtained from application of the present invention are not limited to the aforementioned effects, but other advantageous effects not mentioned above will be clearly understood from the descriptions below by those skilled in the art to which the present invention belongs.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates one example of a network structure of evolved universal terrestrial radio access network (E-UTRAN) to which the present invention can be applied;

FIG. 2 illustrates a radio interface protocol structure defined between a mobile terminal and an E-UTRAN in a wireless communication system to which the present invention can be applied;

FIG. 3 illustrates physical channels used for the 3GPP LTE/LTE-A system to which the present invention can be applied and a general signal transmission method using the physical channels;

FIG. 4 illustrates a radio frame structure defined in the 3GPP LTE/LTE-A system to which the present invention can be applied;

FIG. 5 illustrates a resource grid with respect to one downlink slot in a wireless communication system to which the present invention can be applied;

FIG. 6 illustrates a structure of a downlink subframe in a wireless communication system to which the present invention can be applied;

FIG. 7 illustrates a structure of an uplink subframe in a wireless communication system to which the present invention can be applied;

FIG. 8 illustrates a structure of an ACK/NACK channel for the case of a normal CP in a wireless communication system to which the present invention can be applied;

FIG. 9 illustrates a method for multiplexing ACK/NACK and SR in a wireless communication system to which the present invention can be applied;

FIG. 10 illustrates an MAC PDU used by an MAC entity in a wireless communication system to which the present invention can be applied;

FIGS. 11 and 12 illustrate a sub-header of an MAC PDU in a wireless communication system to which the present invention can be applied;

FIG. 13 illustrates a format of an MAC control element for reporting a buffer state in a wireless communication system to which the present invention can be applied;

FIG. 14 illustrates one example of a component carrier and carrier aggregation in a wireless communication system to which the present invention can be applied;

FIG. 15 illustrates a contention-based random access procedure in a wireless communication system to which the present invention can be applied;

FIG. 16 illustrates a non-contention based random access procedure in a wireless communication system to which the present invention can be applied;

FIG. 17 illustrates an uplink resource allocation process of a mobile terminal in a wireless communication system to which the present invention can be applied;

FIG. 18 illustrates latency required for each process of a contention-based random access procedure required by the 3GPP LTE-A system to which the present invention can be applied;

FIG. 19 illustrates latency in a C-plane required in the 3GPP LTE-A system to which the present invention can be applied;

FIG. 20 illustrates transition time of a synchronized terminal from a dormant state to an active state required in the 3GPP LTE-A system to which the present invention can be applied;

FIG. 21 is a flow diagram illustrating one example of a method for resource allocation of a physical uplink control channel for buffer status report (BSR PUCCH) according to the present invention;

FIG. 22 illustrates one example of an uplink physical control channel format according to the present invention;

FIGS. 23 to 51 illustrate other examples of the uplink physical control channel format according to the present invention; and

FIG. 52 illustrates a block diagram of a wireless communication device to which methods according to the present invention can be applied.

### MODE FOR INVENTION

In what follows, preferred embodiments according to the present invention will be described in detail with reference to appended drawings. The detailed descriptions given below with reference to appended drawings are intended only to provide illustrative embodiments of the present invention and do not represent the only embodiments thereof. The detailed descriptions of the present invention below include specific details for the purpose of comprehensive understanding of the present invention. However, those skilled in the art may readily understand that the present invention can be implemented without those specific details.

For some case, in order to avoid inadvertently making the technical concept of the present invention obscured, the structure and the apparatus well-known to the public can be omitted or illustrated in the form of a block diagram with respect to essential functions of the structure and the apparatus.

A base station in this document is defined as a terminal node of a network which carries out communication directly with a terminal. Particular operations in this document described to be carried out by a base station may be carried out by an upper node of the base station depending on the situation. In other words, it is evident that in a network consisting of a plurality of network nodes including a base station, various operations carried out for communication with terminals can be carried out the base station or other network nodes other than the base station. The term of base station (BS) can be substituted for by those terms such as fixed station, Node B, evolved-NodeB (eNB), base transceiver system (BTS), and access point (AP). Also, a terminal may be stationary or mobile and can be referred to by different terms such as a User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, and Device-to-Device (D2D) device.

In what follows, downlink transmission denotes communication from the BS to the UE, and uplink transmission denotes communication from the UE to the BS. In the downlink transmission, a transmitter can be a part of the BS while a receiver can be a part of the UE. In the uplink transmission, a transmitter can be a part of the UE while a receiver can be a part of the base station.

Particular terms used in the descriptions below are introduced to help understand the present invention and can be modified in various other ways as long as a modified use thereof does not depart from the technical principles and concept of the present invention.

Technologies described below can be used by various wireless access systems based on the scheme such as CDMA (code division multiple access), FDMA (frequency division multiple access), TDMA (time division multiple access), OFDMA (orthogonal frequency division multiple access), SC-FDMA (single carrier frequency division multiple access), and NOMA (non-orthogonal multiple access). The CDMA scheme can be implemented by a radio technology such as universal terrestrial radio access (UTRA) and CDMA2000. The TDMA scheme can be implemented by a radio technology such as global system for mobile communications (GSM), general packet radio service (GPRS), and enhanced data rates for GSM evolution (EDGE). The OFDMA scheme can be implemented by such as radio technology as defined by the IEEE 802.11 (Wi-Fi), IEEE 802.16 (WiMAX), IEEE 802.20, and evolved UTRA (E-UTRA). The UTRA is a part of standards specifying the universal mobile telecommunications system (UMTS). The 3^{rd} generation partnership project (3GPP) long term evolution (LTE) is a part of standards of the evolved UMTS (E-UMTS) employing the E-UTRA, employing the OFDMA scheme for downlink transmission and the SC-FDMA scheme for uplink transmission. The LTE-A (Advanced) is an enhancement of the 3GPP LTE standard.

The embodiments of this document can be supported by at least one of the standard specifications for wireless access systems such as the IEEE 802, 3GPP, and 3GPP2. In other words, the standard specifications can be used to support those steps or parts among the embodiments of the present invention not explicitly described in favor of clarifying the technical principles thereof. Also, for technical definitions of the terms used in this document, the standard documents should be consulted.

For the purpose of clarity, this document is described based on the 3GPP LTE/LTE-A standard; however, it should be understood that the present invention is not limited to the specific standard.

The Overall System

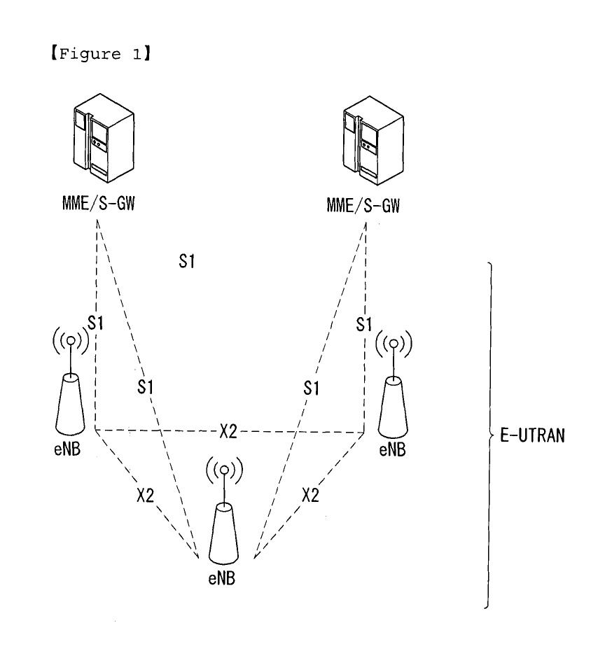

FIG. 1 illustrates one example of a network structure of the evolved universal terrestrial radio access network (E-UTRAN) to which the present invention can be applied.

The E-UTRAN system is an enhancement of the UTRAN system, and can be referred to as the 3GPP LTE/LTE-A system. The E-UTRAN system includes eNBs which provide a control plane and a user plane to a UE, and the eNBs are connected to each other through X2 interface. The X2 user plane interface (X2-U) is defined among the eNBs. The X2-U interface is intended to provide non-guaranteed delivery of a user plane's packet data unit (PDU). The X2 control plane interface (X2-CP) is defined between two neighboring eNBs. The X2-CP performs the function of context delivery between eNBs, control of a user plane turnnel between a source eNB and a target eNB, delivery of handover-related messages, and uplink load management. An eNB is connected to a UE through an air interface and connected to an evolved packet core (EPC) through the S1 interface. The S1 user plane interface (S1-U) is defined between an eNB and a serving gateway (S-GW). The S1 control plane interface (S1-MME) is defined between an eNB and a mobility management entity (MME). The Si interface performs an evolved packet system (EPS) bearer service management function, a non-access stratum (NAS) signaling transport function, network sharing, an MME load balancing function, and so on. The S1 interface supports many-to-many relation between an eNB and an MME/S-GW.

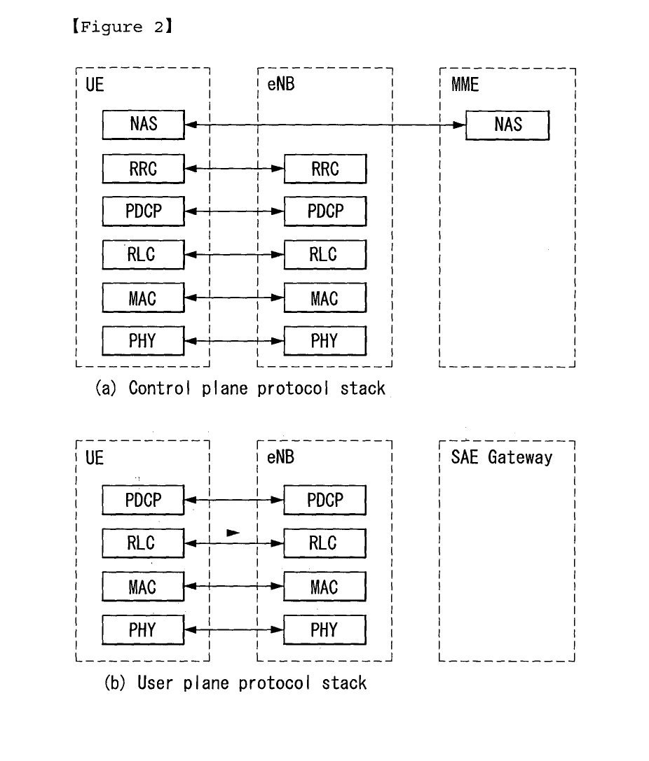

FIG. 2 illustrates a radio interface protocol structure defined between a UE and an E-UTRAN in a wireless communication system to which the present invention can be applied. FIG. 2(a) illustrates a radio protocol structure of a control plane, and FIG. 2(b) illustrates a radio protocol structure of a user plane.

With reference to FIG. 2, layers of a radio interface protocol between the UE and the E-UTRAN can be classified into a first layer (L1), a second layer (L2), and a third layer (L3) based on the lower three layers of the open system interconnection (OSI) model that is well-known in the communication system technology field. The radio interface protocol between the UE and the E-UTRAN is divided horizontally into a physical layer, a data link layer, and a network layer; and divided vertically into a user plane which is a protocol stack for data information transmission and a control plane which is a protocol stack for transmission of a control signal.

The control plane refers to a path along which control messages for the UE and the network to manage calls are transmitted. The user plane refers to a path along which data created in the application layer, for example, voice data or Internet packet data are transmitted. In what follows, the control plane and the user plane of the radio protocol will be described. The physical (PHY) layer belonging to the first layer provides an information transfer service to an upper layer by using a physical channel. The PHY layer is connected to the medium access control (MAC) layer belonging to the upper layer through a transport channel, and data are transferred between the MAC layer and the PHY layer through the transport channel. The transport channel is classified according to how and with what characteristics data are transferred through a radio interface. And a physical channel is employed to transfer data between disparate physical layers and between a physical layer of a transmitter end and a physical layer of a receiver end. The physical layer is modulated by OFDM scheme and uses time and frequency as radio resources.

There are a few physical control channels used in the physical layer. A physical downlink control channel (PDCCCH) informs the UE of a paging channel (PCH), resource allocation of a downlink shard channel (DL-SCH), and hybrid automatic repeat request (HARQ) information related to an uplink shared channel (UL-SCH). Also, the PUCCH can carry an uplink grant which informs the UE of resource allocation for uplink transmission. A physical control format indicator channel (PDFICH) informs the UE of the number of OFDM symbols used for the PDCCHs and is transmitted for each subframe. A physical HARQ indicator channel (PHICH) carries a HARQ acknowledge (ACK)/non-acknowledge (NACK) signal in response to the uplink transmission. A physical uplink control channel (PUCCH) carries requests scheduling of the HARQ ACK/NACK signal for downlink transmission and carries uplink control information such as a channel quality indicator (CQI). A physical uplink shared channel (PUSCH) carries an UL-SCH.

The MAC layer of the second layer (L2) provides a service to its upper layer, radio link control (RLC) layer, through a logical channel. Functions of the MAC layer includes mapping between a logical channel and a transport channel; and multiplexing/demultiplexing of transport blocks provided to a physical channel on a transport channel of a MAC service data unit (SDU) belonging to the logical channel.

The RLC layer of the second layer (L2) supports reliable transmission of data. Functions of the RLC layer include concatenation, segmentation, and reassembly of the RLC SDU. To ensure various levels of quality of service (QoS) that a radio bearer (RB) requests, the RLC layer provides three operating modes: transparent mode (TM), unacknowledged mode (UM), and acknowledge mode (AM). The AM RLC provides error correction through an automatic repeat request (ARQ). Meanwhile, in case the MAC layer carries the RLC function, the RLC layer can be included as a functional block of the MAC layer.

A packet data convergence protocol (PDCP) layer of the second layer (L2) carries functions of transfer of user data in the user plane, header compression, and ciphering. The header compression refers to the function of reducing the size of the IP packet header which carries relatively large and unnecessary control information so that Internet protocol (IP) packets such as the Internet protocol version 4 (IPv4) or the Internet protocol version (IPv6) can be transmitted efficiently through a radio interface with narrow bandwidth. Functions of the PDCP layer in the control plane include transfer of plane data and ciphering/integrity protection.

The radio resource control (RRC) layer located in the lowest part of the third layer (L3) is defined only in the control plane. The RRC layer controls radio resources between the UE and a network. To this end, the UE and the network exchanges RRC messages through the RRC layer. The RRC layer controls a logical channel, a transport channel, and a physical channel related to configuration, re-configuration, and release of radio bearers. A radio bearer refers to a logical path that the second layer (L2) provides for data transmission between the UE and the network. Configuring a radio bearer indicates that a radio protocol layer and channel characteristics are defined for providing a particular service and specific parameters and an operating method thereof are set up. A radio bearer is again divided into a signaling RB (SRB) and a data RB (DRB). The SRB is used as a path for transmitting RRC messages in the control plan, and the DRB is used as a path for transmitting user data in the user plane.

The non-access stratum (NAS) layer located in the upper hierarchy of the RRC layer performs the function of session management, mobility management, and so on.

A cell constituting an eNB has bandwidth chosen from among 1.25, 2.5, 5, 10, 2 MHz and provides a downlink or an uplink transmission service to UEs. Bandwidth configuration can be carried out so that different cells have bandwidth different from each other.

Downlink transport channels for transporting data from a network to a UE include a broadcast channel (BCH) which transmits system information, a PCH which transmits a paging message, a DL-SCH which transmits user traffic or a control message. Downlink multicast or broadcast service traffic or a control message may be transmitted through the DL-SCH or through a separate multicast channel (MCH). Meanwhile, uplink transport channels for transporting data from the UE to the network include a random access channel (RACH) which transmits the initial control message and an uplink shared channel which transmits user traffic or a control message.

A logical channel lies in the upper hierarchy of a transport channel and is mapped to the transport channel. A logical channel is divided into a control channel for transmission of control area information and a traffic channel for transmission of user area information. Logical channels include a broadcast control channel (BCCH), a paging control channel (PCCH), a common control channel (CCCH), a dedicated control channel (DCCH), a multicast control channel (MCCH), a dedicated traffic channel (DTCH), and a multicast traffic channel (MTCH).

To manage a UE and mobility of the UE in the NAS layer located in the control plane, an EPS mobility management (EMM) registered state and an EMM-deregistered state can be defined. The EMM registered state and the EMM de-registered sate can be applied to the UE and the MME. As in the case when the UE is powered on for the first time, the UE at its initial stage is in the EMM-deregistered state and carries out a process of registering for a network through an initial attach procedure to connect to the corresponding network. If the connection procedure is carried out successfully, the UE and the MME then make a transition to the EMM-registered state.

Also, to manage signaling connection between the UE and the network, an EPS connection management (ECM) connected state and an ECM-IDLE state can be defined. The ECM-CONNECTED state and the ECM-IDLE state can also be applied to the UE and the MME. The ECM connection includes an RRC connection established between the UE and an eNB and an S1 signaling connection established between the eNB and the MME. The RRC state indicates whether the RRC layer of the UE and the RRC layer of the eNB are connected logically to each other. In other words, if the RRC layer of the UE is connected to the RRC layer of the eNB, the UE stays in an RRC_CONNECTED state. If the RRC layer of the UE and the RRC layer of the eNB are not connected to each other, the UE stays in an RRC_IDLE state.

A network is capable of perceiving existence of a UE in the ECM-CONNECTED state at the cell level and controlling the UE in an effective manner. On the other hand, the network is unable to perceive the existence of a UE in the ECM-IDLE state, and a core network (CN) manages the UE on the basis of a tracking area which is a regional unit larger than the cell. If the UE is in the ECM-IDLE state, the UE carries out discontinuous reception (DRX) that the NAS configures by using the ID assigned uniquely in the tracking area. In other words, the UE can receive broadcast data of system information and paging information by monitoring a paging signal in a particular paging opportunity at each UE-particular paging DRX cycle. When the UE is in the ECM-IDLE state, the network does not hold context information of the UE. Therefore, the UE in the ECM-IDLE state can carry out a mobility-related procedure based on the UE such as cell selection or cell reselection without having to take an order of the network. In case the position of the UE in the ECM-IDLE state changes from the position known to the network, the UE can inform the network about its position through a tracking area update (TAU) procedure. On the other hand, if the UE is in the ECM-CONNECTED state, mobility of the UE is managed by the command of the network. While the UE is in the ECM-CONNECTED state, the network is informed of the cell to which the UE belongs to. Therefore, the network transmits and receives data to and from the UE, controls mobility such as the UE's handover, and carries out cell measurement of neighboring cells.

As described above, in order for the UE to receive a conventional mobile communication service such as voice or data communication, the UE needs to make a transition to the ECM-CONNECTED state. When the UE is powered on for the first time, the UE at its initial stage stays in the ECM-IDLE state similarly as done for the EMM state; if the UE is registered successfully to the corresponding network through the initial attach procedure, the UE and the MME make a transition to the ECM-CONNECTED state. Also, if the UE is registered in the network but radio resources are not assigned as traffic is deactivated, the UE stays in the ECM-IDLE state; if new uplink or downlink traffic is generated for the corresponding UE, the UE and the MME make a transition to the ECM-CONNECTED state through a service request procedure.

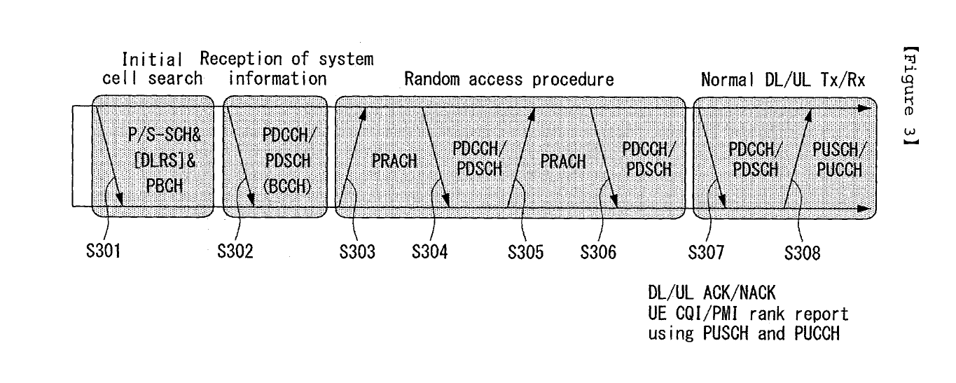

FIG. 3 illustrates physical channels used for the 3GPP LTE/LTE-A system to which the present invention can be applied and a general signal transmission method using the physical channels.

A UE, which may have been powered on again from the power-off state or may have newly entered a cell, carries out the initial cell search task such as synchronizing itself with an eNB in the S301 step. To this purpose, the UE synchronizes with the eNB by receiving a primary synchronization channel (P-SCH) and a secondary synchronization channel (S-SCH) from the eNB and obtains information such as a cell ID (identifier).

Afterwards, the UE receives a physical broadcast channel (PBCH) signal from the eNB and obtains broadcast signal within the eNB. Meanwhile, the UE receives a downlink reference signal (DL RS) in the initial cell search step to check the downlink channel status.

The UE which has finished the initial cell search receives a PDSCH according to the PDCCH and PDCCH information in the S302 step to obtain more specific system information.

Next, the UE may carry out a random access procedure such as the steps of S303 to S306 to complete a connection process to the eNB. To this purpose, the UE transmits a preamble S303 through a physical random access channel (PRACH) and receives a response message in response to the preamble through a PDSCH corresponding to the PRACH S304. In the case of contention-based random access, the UE may carry out a contention resolution procedure including transmission of an additional PRACH signal S305 and reception of a PDCCH signal and the PDSCH signal corresponding to the PDCCH signal S306.

Afterwards, the UE which has carried out the procedure above may carry out reception S307 of the PDCCH signal and/or PDSCH signal and transmission S308 of a PUSCH signal and/or a PUCCH signal as a conventional uplink/downlink signal transmission procedure.

The control information that the UE transmits to the eNB is called collectively uplink control information (UCI). The UCI includes HARQ-ACK/NACK, a scheduling request (SR), a channel quality indicator (CQI), a precoding matrix indicator (PMI), and rank indication (RI) information.

In the LTE/LTE-A system, the UCI is transmitted periodically through the PUCCH; the UCI can be transmitted through the PUSCH if control information and traffic data have to be transmitted at the same time. Also, the UCI can be transmitted non-periodically through the PUSCH according to a request or a command from the network.

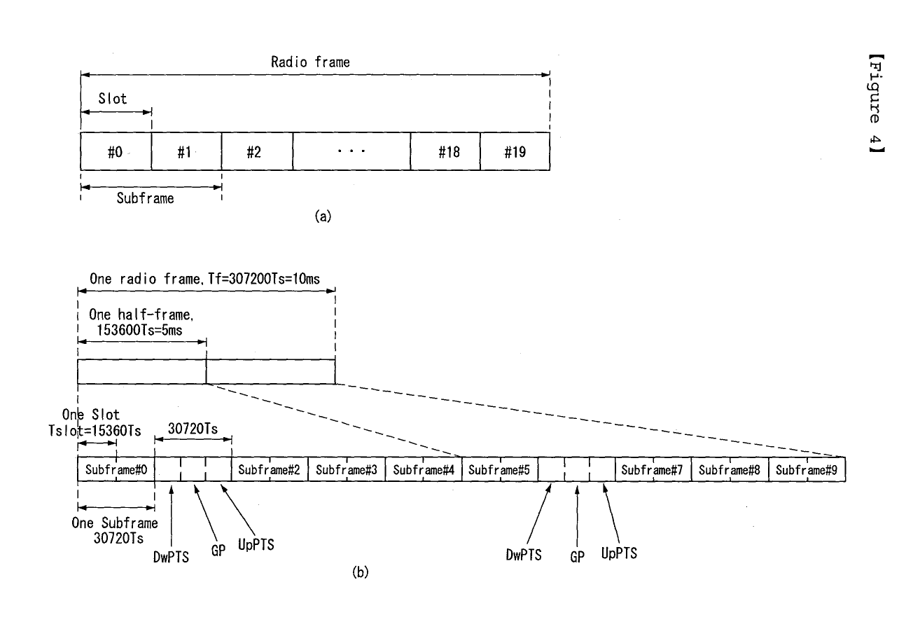

FIG. 4 illustrates a radio frame structure defined in the 3GPP LTE/LTE-A system to which the present invention can be applied.

In the cellular OFDM wireless packet communication system, transmission of uplink/downlink data packets is carried out in units of subframes, and one subframe is defined as a predetermined time period including a plurality of OFDM symbols. The 3GPP LTE/LTE-A standard supports a type 1 radio frame structure that can be applied to frequency division duplex (FDD) scheme and a type 2 radio frame structure that can be applied to time division duplex (TDD) scheme. In the FDD mode, uplink transmission and downlink transmission are carried out separately in the respective frequency bands. On the other hand, for the TDD mode, uplink and downlink transmission are carried out separately in the time domain but occupy the same frequency band. Channel responses in the TDD mode are in fact reciprocal. This implies that a downlink channel response is virtually the same as the corresponding uplink channel response in the frequency domain. Therefore, it can be regarded as an advantage for a wireless communication system operating in the TDD mode that a downlink channel response can be obtained from an uplink channel response. Since the whole frequency domain is so utilized in the TDD mode that uplink and downlink transmission are performed in time division fashion, downlink transmission by an eNB and uplink transmission by a UE cannot be performed simultaneously. In a TDD system where uplink and downlink transmission are managed in units of subframes, uplink and downlink transmission are carried out separately in the respective subframes.

FIG. 4(a) illustrates a structure of a type 1 radio frame. A downlink radio frame consists of 10 subframes, and each subframe consists of two slots in the time domain. The time period needed to transmit one subframe is called a Transmission Time Interval (TTI). For example, length of each subframe can amount to 1 ms, and length of each slot can be 0.5 ms. Each slot includes a plurality of orthogonal frequency division multiplexing (OFDM) symbols in the time domain, and includes a plurality of resource blocks (RBs) in the frequency domain. The 3GPP LTE/LTE-A system uses the OFDMA method for downlink transmission; therefore, the OFDM symbol is intended to represent one symbol period. One OFDM symbol may be regarded to correspond to one SC-FDMA symbol or a symbol period. The resource block as a unit for allocating resources includes a plurality of consecutive subcarriers within one slot.

The number of OFDM symbols included within one slot can be varied according to the configuration of a cyclic prefix. The CP has an extended CP and a normal CP. For example, in case the OFDM symbol consists of normal CPs, the number of OFDM symbols included within one slot can be 7. In case the OFDM symbol consists of extended CPs, the number of OFDM symbols included within one slot becomes smaller than that for the normal CP case since the length of a single OFDM is increased. In the case of extended CP, for example, the number of OFDM symbols included within one slot can be 6. In case a channel condition is unstable as observed when the UE moves with a high speed, the extended CP can be used to further reduce inter-symbol interference.

Since each slot consists of 7 OFDM symbols when a normal CP is used, one subframe includes 14 OFDM symbols. At this time, the first maximum 3 OFDM symbols of each subframe are allocated to the physical downlink control channel (PDCCH) and the remaining OFDM symbols are allocated to the physical downlink shared channel (PDSCH).

FIG. 4(b) illustrates a type 2 radio frame. The type 2 radio frame consists of two half frames, and each half frame consists of 5 subframes, and each subframe consists of two slots. Among the 5 subframes, a special subframe consists of a downlink pilot time slot (DwPTS), a guard period (GP), and an uplink pilot time slot (UpPTS). The DwPTS is used for the UE to carry out the initial cell search, synchronization, and channel estimation. The UpPTS is used for the eNB to carry out channel estimation and uplink transmission synchronization with the UE. The GP is a period intended for removing interference generated during uplink transmission due to multi-path delay of a downlink signal between uplink and downlink transmission.

The structure of a radio frame described above is just an example, and the number of subframes included within one radio frame, the number of slots included within one subframe, and the number of symbols included within one slot can be varied in many ways.

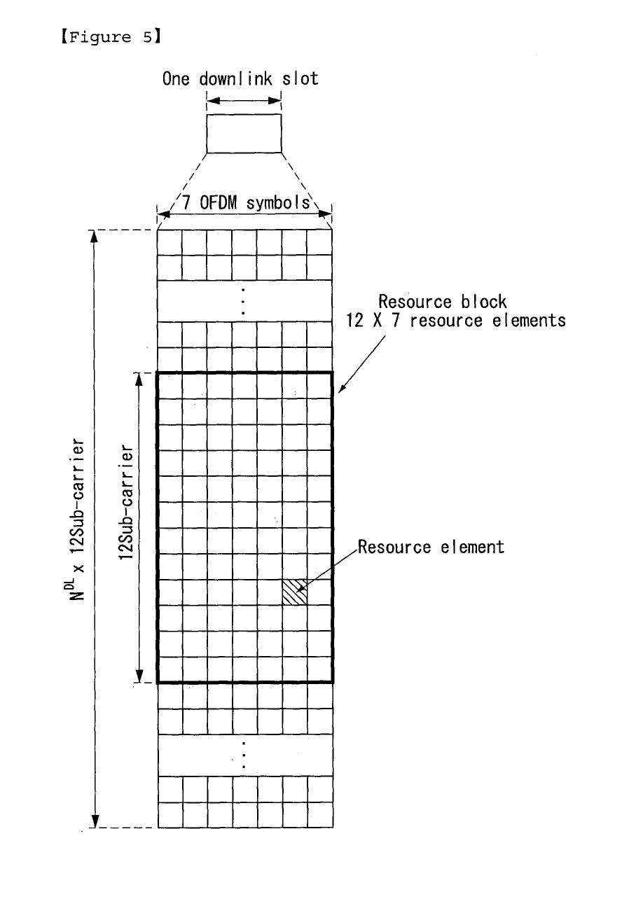

FIG. 5 illustrates a resource grid with respect to one downlink slot in a wireless communication system to which the present invention can be applied.

With reference to FIG. 5, one downlink slot includes a plurality of OFDM symbols in the time domain. Each downlink slot includes 7 OFDM symbols, and each resource block includes 12 subcarriers in the frequency domain. However, the present invention is not limited to the illustrative configuration.

Each element of resource grids is called a resource element, and a resource block includes 12×7 resource elements. Each resource element in the resource grids can be identified by an index pair (k, t) within a slot. Here, k (k=0, . . . , N_{RB}×12−1) stands for a subcarrier index in the frequency domain while l (t=0, . . . , 6) an OFDM symbol index in the time domain. The number N_{RB} of resource blocks included in a downlink slot is dependent on downlink transmission bandwidth. The structure of an uplink slot can be the same as that of the downlink slot.

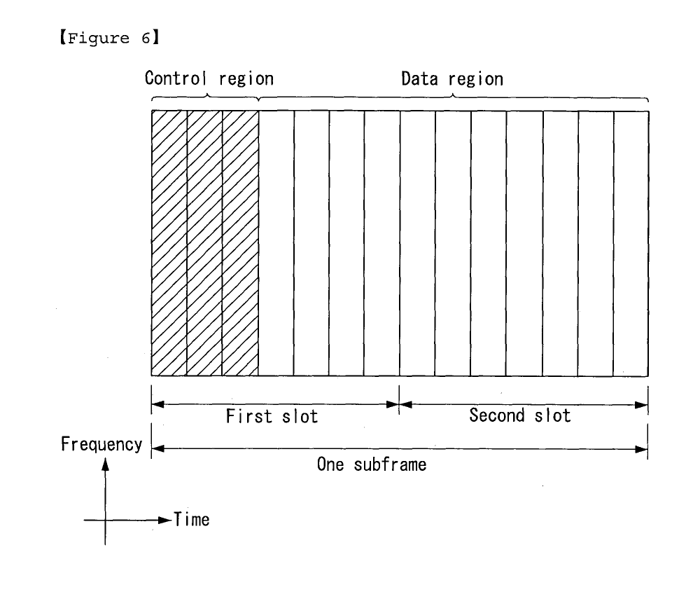

FIG. 6 illustrates a structure of a downlink subframe in a wireless communication system to which the present invention can be applied.

With reference to FIG. 6, in the first slot within a subframe, the first maximum three OFDM symbols make up a control region to which control channels are allocated, and the remaining OFDM symbols form a data region to which a PDSCH is allocated. The 3GPP LTE/LTE-A standard defines PCFICH, PDCCH, and PHICH as downlink control channels.

The PCFICH is transmitted from the first OFDM symbol of a subframe and carries information about the number (namely, size of the control region) of OFDM symbols used for transmission of control channels within a subframe. The PHICH is a response channel with respect to an uplink and carries a ACK/NACK signal with respect to HARQ. The control information transmitted through the PDCCH is called downlink control information (DCI). The DCI includes uplink resource allocation information, downlink resource allocation information, or uplink transmission (Tx) power control commands for an arbitrary UE group.

An eNB determines the PDCCH format according to Downlink Control Information (DCI) to be sent to a UE and adds a Cyclic Redundancy Check (CRC) to the control information. The CRC is masked with a unique identifier depending on an owner of the PDCCH or intended use of the PDCCH, which is called a Radio Network Temporary Identifier (RNTI). In the case of a PDCCH intended for a particular UE, a unique identifier for the UE, for example, Cell-RNTI (C-RNTI) can be masked with the CRC. Similarly, the CRC can be masked with a paging identifier, for example, Paging-RNTI (P-RNTI) in the case of a PDCCH intended for a paging message. The CRC can be masked with a system information identifier, for example, System Information-RNTI (SI-RNTI) in the case of a PDCCH intended for system information block. The CRC can be masked with a Random Access-RNTI (RA-RNTI) to designate a random access response in response to transmission of a random access preamble of the UE.

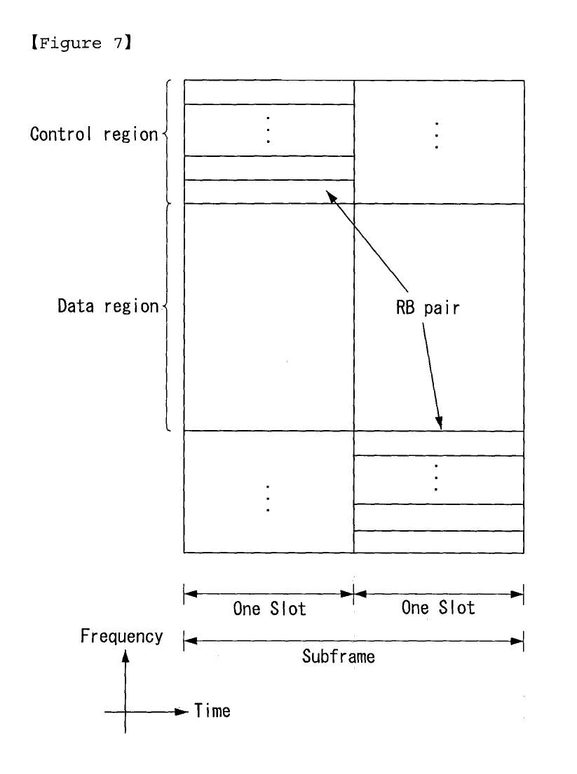

FIG. 7 illustrates a structure of an uplink subframe in a wireless communication system to which the present invention can be applied.

With reference to FIG. 7, an uplink subframe is divided into a control region and a data region in the frequency domain. A PUCCH which carries uplink control information is allocated to the control region. A PUSCH which carries data is allocated to the data region. If an upper layer commands, the UE can support the PUSCH and the PUCCH at the same time. A resource block pair is allocated within a subframe for the PUCCH of each UE. The resource blocks belonging to a resource block pair allocated to the PUCCH occupy different subcarriers at each of two slots based on a slot boundary. In this case, the resource block pair allocated to the PUCCH is said to perform frequency hopping at slot boundaries.

Physical Downlink Control Channel (PDCCH)

The control information transmitted through a PDCCH is called downlink control indicator (DCI). The size and use of the control information transmitted through the PDCCH vary according to the DCI format, and the size can still be changed according to a coding rate.

Table 1 shows the DCI according to the DCI format.

TABLE 1

| DCI | |
|---|---|
| format | Objectives |
| 0 | Scheduling of PUSCH |
| 1 | Scheduling of one PDSCH codeword |
| 1A | Compact scheduling of one PDSCH codeword |
| 1B | Closed-loop single-rank transmission |
| 1C | Paging, RACH response and dynamic BCCH |
| 1D | MU-MIMO |
| 2 | Scheduling of rank-adapted closed-loop spatial |
| | multiplexing mode |
| 2A | Scheduling of rank-adapted open-loop spatial |
| | multiplexing mode |
| 3 | TPC commands for PUCCH and PUSCH with 2 bit power |
| | adjustments |
| 3A | TPC commands for PUCCH and PUSCH with single bit |
| | power adjustments |
| 4 | the scheduling of PUSCH in one UL cell with multi- |
| | antenna port transmission mode |

With reference to Table 1, each value of the DCI format indicates the following objective: format 0 for scheduling of PUSCH, format 1 for scheduling of one PDSCH codeword, format 1A for compact scheduling of one PDSCH codeword, format 1C for very compact scheduling of DL-SCH, format 2 for PDSCH scheduling in a closed-loop spatial multiplexing mode, format 2A for PDSCH scheduling in an open loop spatial multiplexing mode, format 3 and 3A for transmission of transmission power control (TPC) command for an uplink channel, and format 4 for PUSCH scheduling within one uplink cell in a multi-antenna port transmission mode.

The DCI format 1A can be used for PDSCH scheduling no matter what transmission mode is applied.

The DCI format can be applied separately for each UE, and PDCCHs for multiple UEs can be multiplexed within one subframe. A PDCCH is formed by aggregation of one or a few consecutive control channel elements (CCEs). A CCE is a logical allocation unit used for providing a PDCCH with a coding rate according to the state of a radio channel. One REG comprises four REs, and one CCE comprises nine REGs. To form one PDCCH, {1, 2, 4, 8} CCEs can be used, and each element of the set {i, 2, 4, 8} is called a CCE aggregation level. The number of CCEs used for transmission of a particular PDCCCH is determined by the eNB according to the channel condition. The PDCCH established according to each UE is mapped being interleaved to the control channel region of each subframe according to a CCE-to-RE mapping rule. The position of the PDCCH can be varied according to the number of OFDM symbols for a control channel of each subframe, the number of PHICH groups, transmission antenna, and frequency transition.

As described above, channel coding is applied independently to the PDCCH of each of the multiplexed UEs, and cyclic redundancy check (CRC) is applied. The CRC is masked with a unique identifier (ID) of each UE so that the UE can receive its PDCCH. However, the eNB does not inform the UE about the position of the corresponding PDCCH in the control region allocated within a subframe. Since the UE is unable to get information about from which position and at which CCE aggregation level or in which DCI format the UE's PDCCH is transmitted to receive a control channel transmitted from the eNB, the UE searches for its PDCCH by monitoring a set of PDCCH candidates within the subframe. The above operation is called blind decoding (BD). Blind decoding can be also called blind detection or blind search. The blind decoding refers to the method with which the UE demasks the UE ID in the CRC section and checks any CRC error to determine whether the corresponding PDCCH is the UE's control channel.

In what follows, described will be the information transmitted through the DCI format 0.

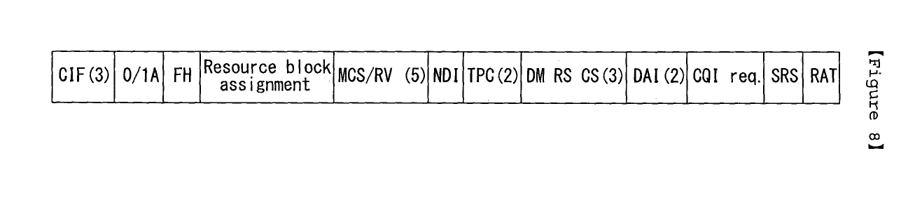

FIG. 8 illustrates a structure of DCI format 0 in a wireless communication system to which the present invention can be applied.

The DCI format 0 is used for scheduling a PUSCH in an uplink cell.

Table 2 shows the information transmitted through the DCI format 0.

TABLE 2

| Format 0 (Release 8) | Format 0 (Release 10) |
|---|---|
| | Carrier Indicator (CIF) |
| Flag for format 0/format 1A | Flag for format 0/format 1A |
| differentiation | differentiation |
| Hopping flag (FH) | Hopping flag (FH) |
| Resource block assignment | Resource block assignment |
| (RIV) | (RIV) |
| MCS and RV | MCS and RV |
| NDI (New Data Indicator) | NDI (New Data Indicator) |
| TPC for PUSCH | TPC for PUSCH |
| Cyclic shift for DM RS | Cyclic shift for DM RS |
| UL index (TDD only) | UL index (TDD only) |
| Downlink Assignment Index | Downlink Assignment Index |
| (DAI) | (DAI) |
| CSI request (1 bit) | CSI request (1 or 2 bits: 2 |
| | bit is for multi carrier) |
| | SRS request |
| | Resource allocation type |
| | (RAT) |

With reference to FIG. 8 and Table 2, the information transmitted through the DCI format 0 is as follows.

1) Carrier indicator—consists of 0 or 3 bits.

2) Flag for identifying the DCI format 0 and format 1A—consists of 1 bit, where 0 indicates the DCI format 0 and 1 indicates the DCI format 1A.

3) Frequency hopping flag—consists of 1 bit. This field can be used to allocate the most significant bit (MSB) of the corresponding resource allocation for multi-cluster allocation depending on the needs.

Resource block assignment and hopping resource allocation—consists of ┌log₂(N_{RB}^{DL}(N_{RB}^{DL}+1)/2)┐ bits.

In the case of PUSCH hopping for single-cluster allocation, NUL_hop MSBs are used to obtain the value of ñ_{PRB}(i). The (┌log₂(N_{RB}^{UL}(N_{RB}^{UL}+1)/2)┐−N_{UL}_{ₕₒₚ}) bit provides resource allocation of the first slot within an uplink subframe. Also, in case there is no PUSCH hopping for single-cluster allocation, the (┌log₂(N_{RB}^{UL}(N_{RB}^{UL}+1)/2)┐) bit provides resource allocation within the uplink subframe. Also, in case there is no PUSCH hopping for multi-cluster allocation, resource allocation information is obtained from concatenation of a frequency hopping flag, resource block allocation, and hopping resource allocation field; and the

$$⌈ {log}_{2} ( ( \begin{matrix}{N}_{RB}^{UL} / P + 1 \\ 4\end{matrix} ) ) ⌉$$

bit provides resource allocation within the uplink subframe. At this time, the P value is determined by the number of downlink resource blocks.

5) Modulation and coding scheme—consists of 5 bits.

6) New data indicator—consists of 1 bit.

7) Transmit power control command for PUSCH—consists of 2 bits.

8) Index of cyclic shift for demodulation reference signal (DMRS) and orthogonal cover/orthogonal cover code (OC/OCC)—consists of 3 bits.

9) Uplink index—consists of 2 bits. This field is defined only for the TDD operation according to uplink-downlink configuration 0.

10) Downlink assignment index (DAI)—consists of 2 bits. This field is defined only for the TDD operation according to uplink-downlink configuration 1 to 6.

11) Channel state information (CSI) request—consists of 1 bit or 2 bits. At this time, a two-bit field is applied only when the corresponding DCI is mapped to the UE, for which one or more downlink cells are configured, by Cell-RNTI (C-RNTI) in a UE-specific manner.

12) Sounding reference signal (SRS) request—consists of 0 or 1 bit. At this time, this field is defined only when a scheduling PUSCH is mapped by the C-RNTI in a UE-specific manner.

13) Resource allocation type—consists of 1 bit.

In case the number of information bits within the DCI format 0 is smaller than the payload size of the DCI format 1A (including a padding bit), 0 is added to the DCI format 0 so that the number of information bits is equal to the payload size of the DCI format 1A.

Physical Uplink Control Channel (PUCCH)

A PUCCH carries various types of uplink control information (UCI) as follows according to the format.
Scheduling request (SR): information used for requesting uplink UL-SCH resources. An on-off keying method is used for transmission of an SR.
HARQ ACK/NACK: a response signal with respect to downlink data packet on a PDSCH. HARQ ACK/NACK indicates whether a downlink data packet has been successfully received. In response to a single downlink codeword, ACK/NACK 1 bit is transmitted, and in response to two downlink codewords, ACK/NACK 2 bits are transmitted.
Channel state information (CSI): feedback information about a downlink channel. CSI includes at least one of channel quality indicator (CQI), rank indicator (RI), precoding matrix indicator (PMI), and precoding type indicator (PTI). In what follows, for the convenience of description, CQI is used to represent the various terms above.

A PUCCH can be modulated by BPSK (Binary Phase Shift Keying) and QPSK (Quadrature Phase Shift Keying) methods. Control information of a plurality of UEs can be transmitted through the PUCCH; in case code division multiplexing (CDM) is carried out to identify individual signals of the UEs, a constant amplitude zero auto correlation (CAZAC) sequence of length 12 is usually employed. Since a CAZAC sequence tends to keep a constant amplitude in the time domain and the frequency domain, the CAZAC sequence is useful for the UE to increase coverage by reducing the UE's peak-to-average power ratio (PAPR) or cubic metric (CM). Also, the ACK/NACK information about downlink data transmitted through the PUCCH is covered by an orthogonal sequence or an orthogonal cover (OC).

Also, control information transmitted on the PUCCH can be identified by a cyclically shifted sequence which has a different cyclic shift value from the others. A cyclically shifted sequence can be created by cyclically shifting a base sequence by as many as a predetermined cyclic shift amount. The amount of cyclic shift is specified by a CS index. The number of cyclic shifts available can be varied according to a delay spread of the corresponding channel. Various types of sequences can be used as a base sequence, and the aforementioned CAZAC sequence is one of the examples.

Also, the amount of control information that the UE can transmit from a subframe can be determined according to the number of SC-FDMA symbols available for transmission of the control information (which indicates SC-FDMA symbols excluding the SC-FDMA symbol used for transmission of a reference signal (RS) for coherent detection of the PUCCH, but in the case of a subframe for which a sounding reference signal (SRS) is set up, the last SC-FDMA symbol of the subframe is also excluded).

A PUCCH is defined by 7 different formats according to control information transmitted, a modulation method used, the amount of control information, and so on. Properties of the uplink control information (UCI) transmitted according to each PUCCH format can be summarized as shown in Table 3.

TABLE 3

| PUCCH Format | Uplink Control Information(UCI) |
|---|---|
| Format 1 | Scheduling Request(SR)(unmodulated waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2 | CQI and 1- or 2-bit HARQ ACK/NACK (20 bits) |
| | for extended CP only |
| Format 2a | CQI and 1-bit HARQ ACK/NACK (20 + 1 coded |
| | bits) |
| Format 2b | CQI and 2-bit HARQ ACK/NACK (20 + 2 coded |
| | bits) |
| Format 3 | HARQ ACK/NACK, SR, CSI (48 coded bits) |

With reference to Table 3, the PUCCH format 1 is used for exclusive transmission of a scheduling request (SR). In the case of exclusive transmission of an SR, an unmodulated waveform is applied.

The PUCCH format 1a or 1b is used for transmission of HARQ ACK/NACK (Acknowledgement/Non-Acknowledgement). In case the HARQ ACK/NACK is transmitted exclusively in an arbitrary subframe, the PUCCH format 1a or 1b can be used. HARQ ACK/NACK and SR may be transmitted from the same subframe by using the PUCCH format 1a or 1b.

The PUCCH format 2 is used for transmission of CQI, and the PUCCH format 2a or 2b is used for transmission of CQI and HARQ ACK/NACK. In the case of an extended CP, the PUCCH format 2 may be used for transmission of CQI and HARQ ACK/NACK.

The PUCCH format 3 is used to carry 48 bit encoded UCI. The PUCCH format 3 can carry HARQ ACK/NACK with respect to a plurality of serving cells, SR (in the case it exists), and CSI report about each serving cell.

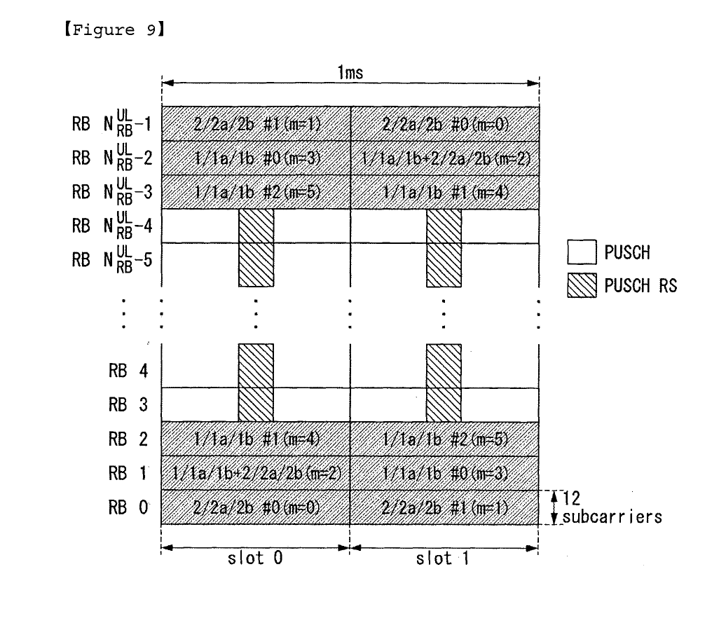

FIG. 9 illustrates one example where PUCCH formats are mapped to the PUCCH region of an uplink physical resource block in a wireless communication system to which the present invention can be applied.

A PUCCH with respect to one UE is allocated to a resource block pair (RB pair) in a subframe. Resource blocks belonging to a resource block pair occupy different subcarriers in each of the first and the second slot. The frequency band occupied by a resource block belonging to the resource block pair allocated to a PUCCH is changed with respect to a slot boundary. In this case, the resource block pair allocated to the PUCCH is said to perform frequency hopping at slot boundaries. The UE, by transmitting uplink control information through subcarriers different with time, frequency diversity gain can be obtained.

In FIG. 9, N_{RB}^{UL} represents the number of resource blocks in uplink transmission, and 0, 1, . . . , N_{RB}^{UL}−1 denotes the number assigned to a physical resource block. By default, the PUCCH is mapped to both ends of an uplink frequency block. As shown in FIG. 9, the PUCCH format 2/2a/2b is mapped to the PUCCH region designated as m=0, 1, which can be interpreted that the PUCCH format 2/2a/2b is mapped to resource blocks located at band edges. Also, the PUCCH format 2/2a/2b and the PUCCH format 1/1a/1b can be mapped being mixed together to the PUCCH region designated as m=2. Next, the PUCCH format 1/1a/1b can be mapped to the PUCCH region designated as m=3, 4, 5. The number N_{RB}⁽²⁾ of PUCCH RBs made available by the PUCCH format 2/2a/2b can be notified to the UEs within a cell through broadcasting signaling.

Table 4 shows a modulation method according to a PUCCH format and the number of bits per subframe. In Table 4, the PUCCH format 2a and 2b correspond to the case of a normal cyclic shift.

TABLE 4

| PUCCH | Modulation | Number of bits per |
|---|---|---|
| format | scheme | subframe, M_{bit} |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |
| 3 | QPSK | 48 |

Table 5 shows the number of symbols of a PUCCH demodulation reference signal per slot according to the PUCCH format.

TABLE 5

| PUCCH format | Normal cyclic prefix | Extended cyclic prefix |
|---|---|---|
| 1, 1a, 1b | 3 | 2 |
| 2, 3 | 2 | 1 |
| 2a, 2b | 2 | N/A |

Table 6 shows SC-FDMA symbol position of a PUCCH demodulation reference signal according to the PUCCH format. In Table 6, l represents a symbol index.

TABLE 6

Set of values for l

| PUCCH format | Normal cyclic prefix | Extended cyclic prefix |
|---|---|---|
| 1, 1a, 1b | 2, 3, 4 | 2, 3 |
| 2, 3 | 1, 5 | 3 |
| 2a, 2b | 1, 5 | N/A |

In what follows, the PUCCH format 2/2a/2b will be described.

The PUCCH format 2/2a/2b is used as CQI feedback (or ACK/NACK transmission along with CQI feedback) with respect to downlink transmission. In order for the CQI and ACK/NACK signal to be transmitted together, the ACK/NACK signal may be transmitted being embedded in the CQI RS (in the case of a normal CP) or transmitted after the CQI and ACK/NACK signal are jointly coded (in the case of an extended CP).

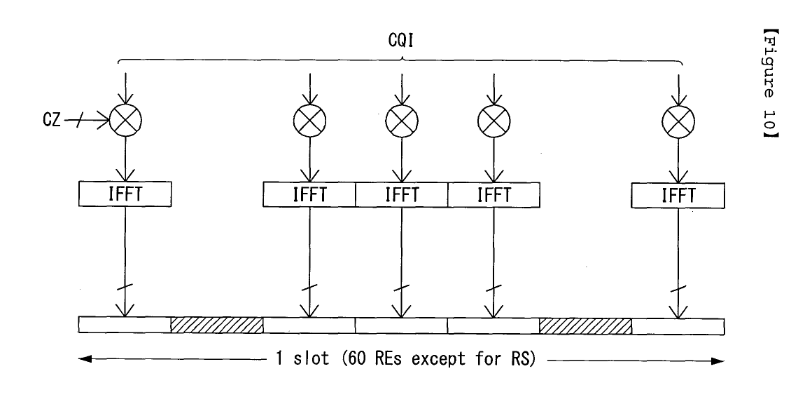

FIG. 10 illustrates a structure of a CQI channel for the case of a normal CP in a wireless communication system to which the present invention can be applied.

Among SC-FDMA symbols 0 to 6 in one slot, SC-FDMA symbol 1 and 5 (the second and the sixth symbol) are used for transmission of a demodulation reference signal (DMRS), and the remaining SC-FDMA symbols are used to transmit CQI information. Meanwhile, in the case of an extended CP, one SC-FDMA symbol (SC-FDMA symbol 3) is used for DMRS transmission.

The PUCCH format 2/2a/2b supports modulation based on a CAZAC sequence, and a QPSK-modulated symbol is multiplied with a CAZAC sequence of length 12. The cyclic shift of the sequence is changed between a symbol and a slot. Orthogonal covering is used for a DMRS.

Among 7 SC-FDMA symbols included in one slot, two SC-FDMA spaced apart from each other by three SC-FDMA symbols carries the DMRS, and the remaining 5 SC-FDMA symbols carry CQI information. The scheme of using two reference signals in one slot is intended to support high-speed UEs. Also, each UE is identified on the basis of a cyclic shift sequence. The CQI information symbols are transmitted being modulated with the entire SC-FDMA symbols, and each SC-FDMA symbol comprises one sequence. In other words, each UE modulates the CQI and transmits the modulated CQI to each sequence.

The number of symbols that can be transmitted to one TTI is 10, and modulation of CQI information is predetermined to use QPSK modulation. The first 5 symbols are transmitted from the first slot, and the remaining 5 symbols are transmitted from the second slot. In case QPSK mapping is used with respect to the SC-FDMA symbol, CQI value of two bits can be dealt with; therefore, each slot can carry CQI value of 10 bits. Accordingly, a maximum of 20 bits can be used for each subframe to carry the CQI value. In order to spread the CQI information in the frequency domain, frequency domain spreading code is used.

For frequency domain spreading code, a CAZAC sequence of length 12 (for example, zc sequence) can be used. Each control channel can be identified by applying the CAZAC sequence with a different cyclic shift value. Inverse fast fourier transform (IFFT) is carried out for frequency domain spread CQI information.

Twelve different UEs can be orthogonally multiplexed on the same PUCCH RB by cyclic shift having 12 equivalent intervals. In the case of normal CP, the DMRS sequence on the SC-FDMA symbol 1 and 5 (in the case of extended CP, on the SC-FDMA symbol 3) is similar to the CQI signal sequence in the frequency domain, but the same modulation as done for the CQI information is not applied.

A UE can be configured semi-statically by upper layer signaling to report different CQI, PMI, and RI types periodically on the PUCCH resources designated by the PUCCH resource index (n_{PUCCH}^{(1,\tilde{p})}, n_{PUCCH}^{(2,\tilde{p})}, n_{PUCCH}^{(3,\tilde{p})}). At this time, the PUCCH resource index (n_{PUCCH}^{(2,\tilde{p})}) corresponds to the information indicating the PUCCH region used for PUCCH format 2/2a/2b transmission and a cyclic shift (CS) value to be used.

Table 7 shows an orthogonal sequence (OC) [w̅^{(\tilde{p})}(0) . . . w̅^{(\tilde{p})}(N_{RS}^{PUCCH}−1)] for an RS defined by the PUCCH format 2/2a/2b/3.

TABLE 7

| Normal cyclic prefix | Extended cyclic prefix |
|---|---|
| [1 1] | [1] |

Next, the PUCCH format 1/1a/1b will be described.

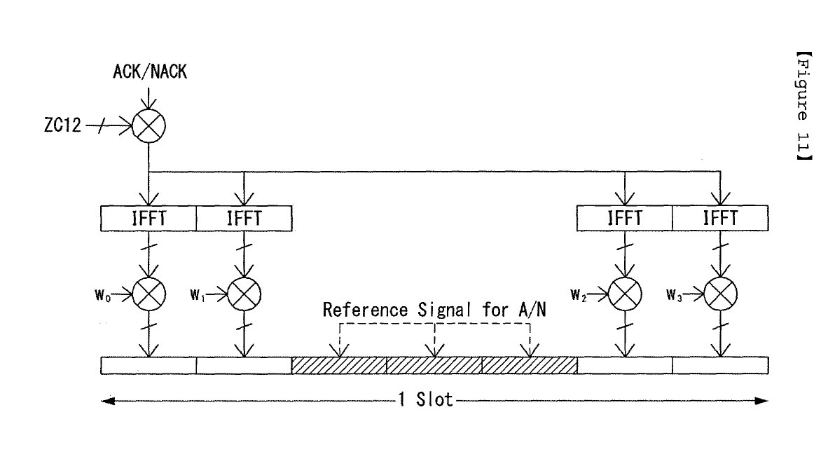

FIG. 11 illustrates a structure of an ACK/NACK channel for the case of a normal CP in a wireless communication system to which the present invention can be applied.

FIG. 11 illustrates a channel structure of a PUCCH intended for transmission of HARQ ACK/NACK signal without using CQI.

The confirmation response information (not scrambled) of 1 bit and 2 bits can be represented by a single HARQ ACK/NACK modulation symbol by using BPSK and QPSK modulation scheme, respectively. Acknowledgement can be encoded as ‘1’ while non-acknowledgement can be encoded as ‘0’.

When a control signal is transmitted within an allocated band, two-dimensional spreading is applied to increase multiplexing capacity. In other words, to increase the number of UEs or control channels that can be multiplexed, frequency and time domain spreading are applied at the same time.

In order to spread the ACK/NACK signal in the frequency domain, a frequency domain sequence is used as a base sequence. For a frequency domain sequence, Zadoff-Chu (ZC) sequence, which is one of the CAZAC sequence, can be used.

In other words, for the case of the PUCCH format 1a/1b, the symbol modulated by using BPSK or QPSK scheme is multiplied with a CAZAC sequence (for example, ZC sequence) of length 12. For example, a modulation symbol d(0) is multiplied with the CAZAC sequence of length N, r(n), where n=0, 1, 2, . . . , N−1, to provide y(0), y(1), y(2), . . . , y(N−1). The y(0), y(1) , . . . , y(N−1) symbols can be called a block of symbols.

In this way, as a different cyclic shift (CS) is applied to the base sequence, ZC sequence, multiplexing of different UEs or control channels can be implemented. The number of CS resources supported by SC-FDMA symbols meant for PUCCH RBs to transmit the HARQ ACK/NACK signal is set by the cell-specific, upper-layer signaling parameter Δ_{shift}^{PUUCH}.

After multiplication of a modulation symbol with the CAZAC sequence, block-wise spreading employing an orthogonal sequence is applied. In other words, the ACK/NACK signal spread in the frequency domain is spread in the time domain by using the orthogonal spreading code. As the orthogonal spreading code (or orthogonal cover sequence) or orthogonal cover code (OCC), the Walsh-Hadamard sequence or Discrete Fourier Transform (DTF) sequence can be used. For example, the ACK/NACK signal can be spread through an orthogonal sequence of length 4 (w0, w1, w2, w3) with respect to four symbols. Also, the RS is also spread through an orthogonal sequence of length 2 or 3. And the above operation is called orthogonal covering (OC).

For the ACK/NACK information or CDM of a demodulation reference signal, orthogonal covering based on the Walsh mode or DRF matrix can be used.

A DFT matrix is an N×N square matrix (where N is a natural number).

A DFT matrix can be defined as shown in Eq. 1.

$$W = {( \frac{{ω}^{{j}^{k}}}{\sqrt{N}} )}_{j , k = 0 , … , N - 1} \qquad [ Eq . 1 ]$$

Equation 1 can be represented as a matrix form as shown in Eq. 2.

$$W = \frac{1}{\sqrt{N}} [ \begin{matrix}1 & 1 & 1 & 1 & … & 1 \\ 1 & ω & {ω}^{2} & {ω}^{3} & … & {ω}^{N - 1} \\ 1 & {ω}^{2} & {ω}^{4} & {ω}^{6} & … & {ω}^{2 ( N - 1 )} \\ 1 & {ω}^{3} & {ω}^{6} & {ω}^{9} & … & {ω}^{3 ( N - 1 )} \\ ⋮ & ⋮ & ⋮ & ⋮ & ⋱ & ⋮ \\ 1 & {ω}^{N - 1} & {ω}^{2 ( N - 1 )} & {ω}^{3 ( N - 1 )} & … & {ω}^{( N - 1 ) ( N - 1 )}\end{matrix} ] , \\ ω = {e}^{- \frac{2 π 1}{N}} \qquad [ Eq . 2 ]$$

in Eq. 2 denotes the primitive N-th root of unity.

A 2-point, 4-point, and 8-point DFT matrix are shown in Eqs. 3, 4, and 5, respectively.

$$\begin{matrix}\frac{1}{\sqrt{2}} [ \begin{matrix}1 & 1 \\ 1 & - 1\end{matrix} ] & [ Eq . 3 ] \\ W = \frac{1}{\sqrt{4}} [ \begin{matrix}1 & 1 & 1 & 1 \\ 1 & - i & - 1 & i \\ 1 & - 1 & 1 & - 1 \\ 1 & i & - 1 & - i\end{matrix} ] & [ Eq . 4 ] \\ W = \frac{1}{\sqrt{8}} [ \begin{matrix}{ω}^{0} & {ω}^{0} & {ω}^{0} & … & {ω}^{0} \\ {ω}^{0} & {ω}^{1} & {ω}^{2} & … & {ω}^{7} \\ {ω}^{0} & {ω}^{2} & {ω}^{4} & … & {ω}^{14} \\ {ω}^{0} & {ω}^{3} & {ω}^{6} & … & {ω}^{21} \\ {ω}^{0} & {ω}^{4} & {ω}^{8} & … & {ω}^{28} \\ {ω}^{0} & {ω}^{5} & {ω}^{10} & … & {ω}^{35} \\ ⋮ & ⋮ & ⋮ & ⋱ & ⋮ \\ {ω}^{0} & {ω}^{7} & {ω}^{14} & … & {ω}^{49}\end{matrix} ] & [ Eq . 5 ]\end{matrix}$$

In the case of a normal CP, 3 consecutive SC-FDMA symbols located in the middle of the 7 SC-FDMA symbols included within one slot carry the reference signal (RS), and the remaining 4 SC-FDMA symbols carry the ACK/NACK signal. On the other hand, in the case of an extended CP, 2 consecutive symbols in the middle thereof can carry the RS. The number and the position of the symbols used for the RS can be varied according to a control channel, and the number and the position of the symbols used for the ACK/NACK signal can also be changed according to the control channel.

For the case of normal ACK/NACK information, the Walsh-Hadamard sequence of length 4 is used, and for the case of shortened ACK/NACK information and reference signal (RS), the DFT sequence of length 3 is used.

For the reference signal (RS) in the case of the extended CP, the Hadamard sequence of length 2 is used.

Table 8 shows an orthogonal sequence (OC) [w(0) . . . w(N_{SF}^{PUCCH}−1)] of length 4 for the PUCCH format 1a/1b.

TABLE 8

| Sequence index | Orthogonal sequences |
|---|---|
| n_{oc}^{(\tilde{p})}(nₛ) | [w(0) . . . w(N_{SF}^{PUCCH} − 1)] |
| 0 | [+1 +1 +1 +1] |
| 1 | [+1 −1 +1 −1] |
| 2 | [+1 −1 −1 +1] |

Table 9 shows an orthogonal sequence [w(0) . . . w(N_{SF}^{PUCCH}−1)] of length 3 for the PUCCH format 1a/1b.

TABLE 9

| Sequence index | Orthogonal sequences |
|---|---|
| n_{oc}^{(\tilde{p})}(nₛ) | [w(0) . . . w(N_{SF}^{PUCCH} − 1)] |
| 0 | [1 1 1] |
| 1 | [1 e^{j2π/3} e^{j4π/3}] |
| 2 | [1 e^{j4π/3} e^{j2π/3}] |

Table 10 shows an orthogonal sequence (OC) [w̅^{(\tilde{p})}(0) . . . w̅^{(\tilde{p})}(N_{RS}^{PUCCH}−1)] for the RS for the PUCCH format 1/1a/1b.

TABLE 10

| Sequence index | Normal cyclic | Extended cyclic |
|---|---|---|
| n̅_{oc}^{(\tilde{p})}(nₛ) | prefix | prefix |
| 0 | [1 1 1] | [1 1] |
| 1 | [1 e^{j2π/3} e^{j4π/3}] | [1 −1] |
| 2 | [1 e^{j4π/3} e^{j2π/3}] | N/A |

As described above, a plurality of UEs can be multiplexed through code division multiplexing (CDM) scheme by using the CS resource in the frequency domain but OC resource in the time domain. In other words, the ACK/NACK information and RS for a large number of UEs can be multiplexed on the same PUCCH RB.

With respect to the time domain spreading CDM, the number of spreading codes supporting the ACK/NACK information is limited by the number of RS symbols. In other words, since the number of SC-FDMA symbols for RS transmission is smaller than the number of SC-FDMA symbols for ACK/NACK information transmission, multiplexing capacity of RS becomes smaller than that of ACK/NACK information.

For example, in the case of a normal CP, ACK/NACK information can be transmitted from 4 symbols. In the case of an extended CP, 3 orthogonal spreading codes rather than 4 can be used for the ACK/NACK information; this is so because the number of RS transmission symbols is limited to 3 and only three orthogonal spreading codes can be used for the RS.

Suppose in a subframe with a normal CP, 3 symbols from one slot are used for RS transmission and 4 symbols are used for ACK/NACK information transmission. If 6 cyclic shifts are available in the frequency domain and 3 orthogonal cover resources in the time domain can be used, the HARQ confirmation responses from a total of 18 different UEs can be multiplexed within one PUCCH RB. Similarly, suppose in a subframe with an extended CP, 2 symbols from one slot are used for RS transmission and 4 symbols are used for ACK/NACK information transmission. If 6 cyclic shifts are available in the frequency domain and 2 orthogonal cover resources in the time domain can be used, the HARQ confirmation responses from a total of 12 different UEs can be multiplexed within one PUCCH RB.

Next, the PUCCH format 1 will be described. A scheduling request (SR) is transmitted in such a way that a UE may or may not request scheduling. An SR channel re-uses the ACK/NACK channel structure for the PUCCH format 1a/1b and configured according to the On-Off Keying (OOK) scheme based on the ACK/NACK channel design. A reference signal is not transmitted through the SR channel. Therefore, in the case of a normal CP, a sequence of length 7 is used while in the case of an extended CP, a sequence of length 6 is used. For the SR and ACK/NACK, a different cyclic shift or orthogonal cover can be allocated.

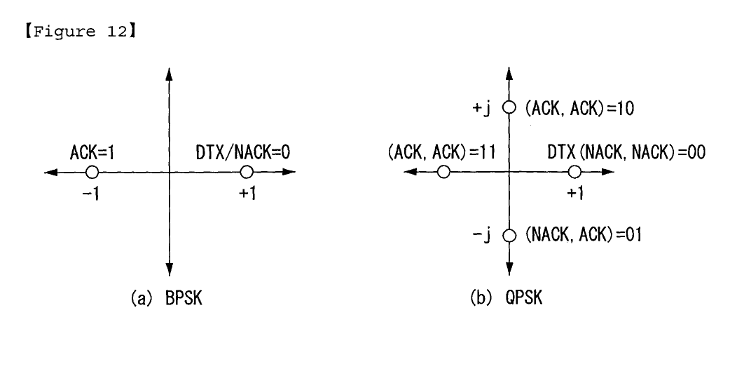

FIG. 12 illustrates a method for multiplexing ACK/NACK and SR in a wireless communication system to which the present invention can be applied.

The structure of the SR PUCCH format 1 is the same as the structure of the ACK/NACK PUCCH format 1a/1b of FIG. 12.

A scheduling request (SR) is transmitted through the OOK scheme. More specifically, the UE transmits an SR which has a modulation symbol d(0)=1 to request PUSCH resources (positive SR) but transmits nothing if not requesting scheduling (negative SR). Since the PUCCH structure for ACK/NACK is re-used for SR, different resource indices within the same PUCCH region (namely, combinations of different cyclic shifts and orthogonal codes) can be allocated to the SR (PUCCH format 1) or HARQ ACK/NACK (PUCCH format 1a/1b). The PUCCH resource index to be used by the UE for SR transmission is set by UE-specific upper layer signaling.

In case the UE needs to transmit a positive SR from a subframe scheduled for CQI transmission, the UE is allowed to drop CQI and to transmit the SR only. Similarly, if the UE needs to transmit the SR and the SRS at the same time, the UE is allowed to drop the CQI and to transmit the SR only.

In case the SR and the ACK/NACK are generated in the same subframe, the UE transmits the ACK/NACK signal on the SR PUCCH resource allocated for positive SR. In the case of negative SR, the UE transmits the ACK/NACK signal on the ACK/NACK resources allocated.

FIG. 12 shows constellation mapping for simultaneous transmission of an ACK/NACK signal and an SR. More specifically, FIG. 12 illustrates that NACK signal (or, in the case of two MIMO codewords, NACK, NACK) is mapped being modulated to +1. Accordingly, occurrence of discontinuous transmission (DTX) is treated as NACK.

For SR and persistent scheduling, the ACK/NACK resources comprising CS, OC, and physical resource blocks (PRBs) can be allocated to the UE through radio resource control (RRC). On the other hand, for the purpose of dynamic ACK/NACK transmission and non-persistent scheduling, ACK/NACK resources can be allocated implicitly to the UE through the lowest CCE index of the PUCCH corresponding to the PDSCH.

The UE can transmit the SR if resources for uplink data transmission are needed. In other words, transmission of the SR is event-triggered.

The SR PUCCH resources are configured by upper layer signaling except for the case the SR is transmitted together with the HARQ ACK/NACK by using the PUCCH format 3. In other words, the SR PUCCH resources are configured by the ScheduleingRequestConfig information element transmitted through the radio resource control (RRC) message (for example, an RRC connection reconfiguration message).

Table 11 shows the ScheduleingRequestConfig information element.

TABLE 11

| -- ASN1START | |
|---|---|
| SchedulingRequestConfig ::= CHOICE { | |
| release | NULL, |
| setup | SEQUENCE { |

| | |
|---|---|
| sr-PUCCH-ResourceIndex | INTEGER (0..2047), |
| sr-ConfigIndex | INTEGER (0..157), |
| dsr-TransMax | ENUMERATED { |
| | n4, n8, n16, n32, n64, |

| spare3, spare2, spare1} | |
|---|---|
| } | |
| } | |
| SchedulingRequestConfig-v1020 ::= | SEQUENCE { |
| sr-PUCCH-ResourceIndexP1-r10 | INTEGER (0..2047) |

OPTIONAL -- Need OR
}
-- ASN1STOP

Table 12, shows the fields included in the SchedulingRequestConfig information element.

TABLE 12
SchedulingRequestConfig field descriptions

dsr-TransMax
Parameter for SR transmission. n4 represents four times of
transmission, n8 eight times of transmission, and so on.
sr-ConfigIndex
Parameter (I_{SR}). 156 and 157 values are not defined in the release 8.
sr-PUCCH-ResourceIndex, sr-PUCCH-ResourceIndexP1
Parameters for antenna port p0 and 01, respectively (n_{PUCCH, SRI}^{(1, p)}). E-
UTRAN configures sr-PUCCH-ResourceIndexP1 only when sr-
PUCCHResourceIndex is set up.

With reference to FIG. 12, the UE receives sr-PUCCH-ResourceIndex parameter for SR transmission through an RRC message and sr-ConfigIndex parameter (I_{SR}) indicating the SR configuration index. The sr-ConfigIndex parameter can be used to configure SR_{PERIODICITY} which indicates the period at which the SR is transmitted and N_{OFFSET,SR} which indicates a subframe from which the SR is transmitted. In other words, the SR is transmitted from a particular subframe repeated periodically according to I_{SR} given by the upper layer. Also, subframe resources and CDM/FDM (Frequency Division Multiplexing) resources can be allocated to the resources for SR.

Table 13 represents an SR transmission period and an SR subframe offset according to an SR configuration index.

TABLE 13

| SR configuration | SR periodicity | SR subframe |
|---|---|---|
| Index | (ms) | offset |
| I_{SR} | SR_{PERIODICITY} | N_{OFFSET, SR} |
| 0-4 | 5 | I_{SR} |
| 5-14 | 10 | I_{SR} − 5 |
| 15-34 | 20 | I_{SR} − 15 |
| 35-74 | 40 | I_{SR} − 35 |
| 75-154 | 80 | I_{SR} − 75 |
| 155-156 | 2 | I_{SR} − 155 |
| 157 | 1 | I_{SR} − 157 |

Buffer Status Reporting (BSR)

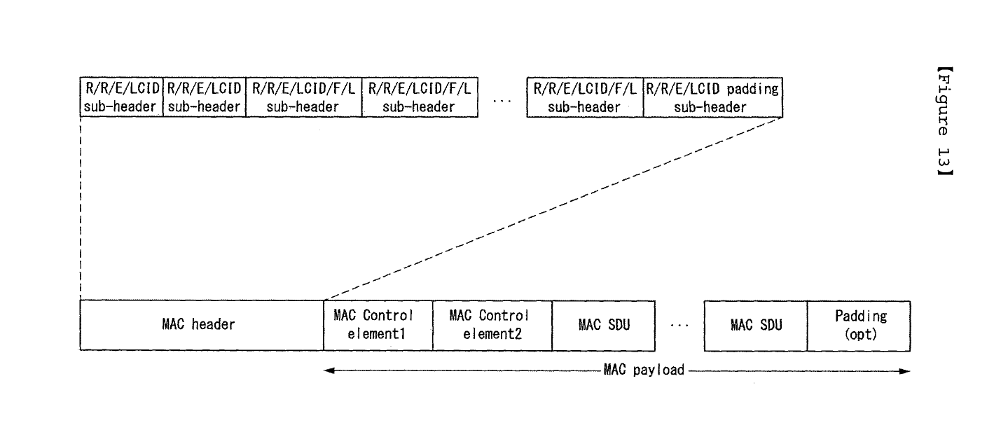

FIG. 13 illustrates an MAC PDU used by an MAC entity in a wireless communication system to which the present invention can be applied.

With reference to FIG. 13, the MAC PDU includes an MAC header, at least one MAC service data unit (SDU), and at least one MAC control element; and may further comprise padding. Depending on the situation, at least one of the MAC SDU and the MAC control element may not be included in the MAC PDU.

As shown in FIG. 13, the MAC control element usually precedes the MAC SDU. And the size of the MAC control element can be fixed or varied. In case the size of the MAC control element is variable, whether the size of the MAC control element has been increased can be determined through an extended bit. The size of the MAC SDU can also be varied.

The MAC header can include at least one or more sub-headers. At this time, at least one or more sub-headers included in the MAC header correspond to the MAC SDU, MAC control element, and padding, respectively, which the order of the sub-headers is the same as the disposition order of the corresponding elements. For example, as shown in FIG. 10, if the MAC PDU includes an MAC control element 1, an MAC control element 2, a plurality of MAC SDUs, and padding, sub-headers can be disposed in the MAC header so that a sub-header corresponding to the MAC control element 1, a sub-header corresponding to the MAC control element 2, a plurality of sub-headers corresponding respectively to the plurality of MAC SDUs, and a sub-header corresponding to padding can be disposed according to the corresponding order.

The sub-header included in the MAC header, as shown in FIG. 10, can include 6 header fields. More specifically, the sub-header can include 6 header fields of R/R/E/LCID/F/L.

As shown in FIG. 10, for the sub-header corresponding to the MAC control element of a fixed size and the sub-header corresponding to the last one among the data fields included in the MAC PDU, sub-headers including header fields can be used. Therefore, in case a sub-header includes 4 fields, the four fields can be R/R/E/LCID.

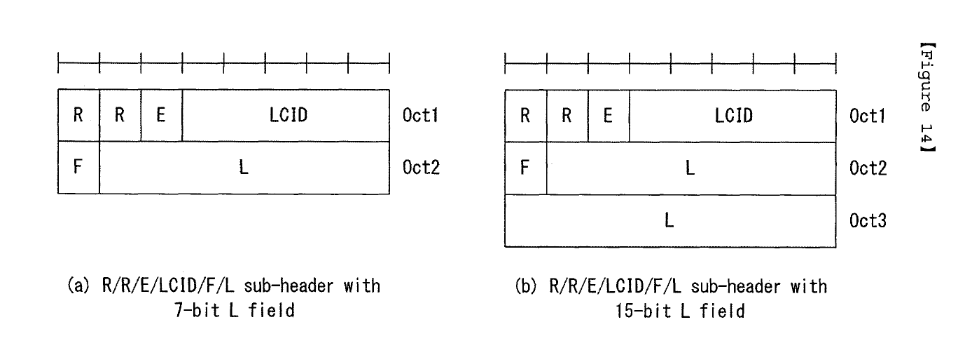

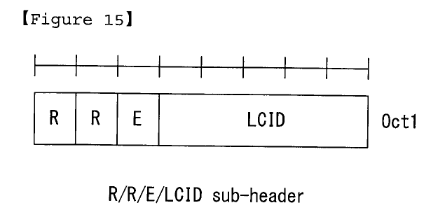

FIGS. 14 and 15 illustrate a sub-header of an MAC PDU in a wireless communication system to which the present invention can be applied.

In the following, each field is described with reference to FIGS. 14 and 15.

1) R: Reserved bit, not used.

2) E: Extended bit, indicating whether the element corresponding to a sub-header is extended. For example, if E field is ‘0’, the element corresponding to the sub-header is terminated without repetition; if E field is ‘1’, the element corresponding to the sub-header is repeated one more time and the length of the element is increased twice of the original length.

3) LCID: Logical Channel Identification. This field is used for identifying a logical channel corresponding to the MAC SDU or identifying the corresponding MAC control element and padding type. If the MAC SDU is related to a sub-header, this field then indicates a logical channel which the MAC SDU corresponds to. If the MAC control element is related to a sub-header, then this field can describe what the MAC control element is like.

Table 14 shows the LCID values for DL-SCH.

TABLE 14

| Index | LCID values |
|---|---|
| 00000 | CCCH |
| 00001-01010 | Identity of the logical channel |
| 01011-11001 | Reserved |
| 11010 | Long DRX Command |
| 11011 | Activation/Deactivation |
| 11100 | UE Contention Resolution Identity |
| 11101 | Timing Advance Command |
| 11110 | DRX Command |
| 11111 | Padding |

Table 15 shows LCID values for UL-SCH.

TABLE 15

| Index | LCID values |
|---|---|
| 00000 | CCCH |
| 00001-01010 | Identity of the logical channel |
| 01011-11000 | Reserved |
| 11001 | Extended Power Headroom Report |
| 11010 | Power Headroom Report |
| 11011 | C-RNTI |
| 11100 | Truncated BSR |
| 11101 | Short BSR |
| 11110 | Long BSR |
| 11111 | Padding |

In the LTE/LTE-A system, a UE can report its buffer state to the network by setting an index value for any of a truncated BSR in the LCID field, a short BSR, and a long BSR.

The index values and a mapping relationship of the LCID values of Tables 14 and 15 are shown for an illustrative purpose, and the present invention is not limited to the example.

4) F: Format field. Represents the size of the L field

5) L: Length field. Represents the size of the MAC SDU corresponding to a sub-header and the size of the MAC control element. If the size of the MAC SDU corresponding to a sub-header or the size of the MAC control element is equal to or smaller than 127 bits, 7 bits of the L field can be used (FIGS. 14(a)) and 15 bits of the L field can be used for the other cases (FIG. 14(b)). In case the size of the MAC control element varies, the size of the MAC control element can be defined through the L field. In case the size of the MAC control element is fixed, the F and the L field may be omitted as shown in FIG. 15 since the size of the MAC control element can be determined without defining the size of the MAC control element through the L field.

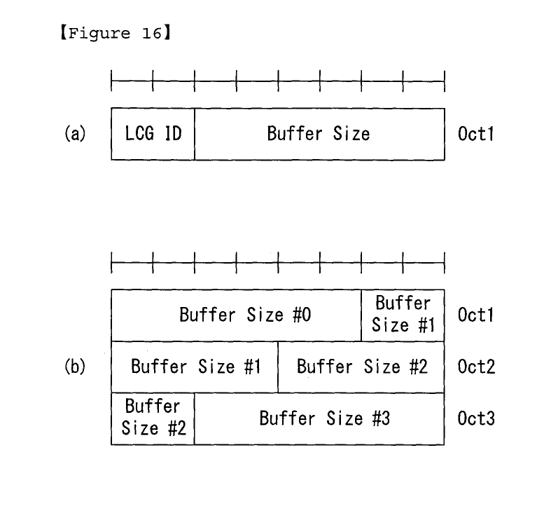

FIG. 16 illustrates a format of an MAC control element for reporting a buffer state in a wireless communication system to which the present invention can be applied.

In case the truncated BSR and short BSR are defined in the LCID field, the MAC control element corresponding to a sub-header can be configured to include a logical channel group identification (LCG ID) field and a buffer size field indicating a buffer state of the logical channel group as shown in FIG. 16(a). The LCG ID field is intended to identify a logical channel group to which to report a buffer state and can have the size of two bits.

The buffer size field is intended to identify the total amount of data available for all of the logical channels belonging to a logical channel group after the MAC PDU is created. The available data include all of the data that can be transmitted from the RLC layer and the PDCP layer, and the amount of data is represented by the number of bytes. The buffer size field can have the size of 6 bits.

In case a long BSR is defined for the LCID field of a sub-header, the MAC control element corresponding to a sub-header can include 4 buffer size fields indicating buffer states of the four groups having LCG IDs ranging from 0 to 3 as shown in FIG. 16(b). Each buffer size field can be used to identify the total amount of data available for each logical channel group.

Carrier Aggregation in General

Communication environments considered in the embodiments of the present invention includes all of multi-carrier supporting environments. In other words, a multi-carrier system or a carrier aggregation system according to the present invention refers to the system utilizing aggregation of one or more component carriers having bandwidth narrower than target bandwidth to establish a broadband communication environment.

A multi-carrier according to the present invention refers to aggregation of carriers, and the carrier aggregation in this sense refers to not only the aggregation of contiguous carriers but also the aggregation of non-contiguous carriers. Also, the numbers of component carriers aggregated for downlink and uplink transmission can be set differently from each other. The case where the number of downlink component carriers (hereinafter, it is called ‘DL CC’) is the same as the number of uplink component carriers (hereinafter, it is called ‘UL CC’) is called symmetric aggregation, whereas it is called asymmetric aggregation otherwise. The term of carrier aggregation may be used interchangeably with bandwidth aggregation and spectrum aggregation.

Carrier aggregation composed of a combination of two or more component carriers is intended to support bandwidth of up to 100 MHz for the case of the LTE-A system. When one or more carriers having narrower bandwidth than target bandwidth are combined, the bandwidth of the carrier to be combined can be limited to the bandwidth defined by an existing system to maintain compatibility with the existing IMT system. For example, while the existing system supports bandwidth of 1.4, 3, 5, 10, 15, and 20 MHz, the 3GPP LTE-A system can support bandwidth larger than 20 MHz by using a combination of the predefined bandwidth to maintain compatibility with the existing system. Also, a carrier aggregation system according to the present invention may support carrier aggregation by defining new bandwidth independently of the bandwidth used in the existing system.

The LTE-A system introduces a concept of a cell for management of radio resources.

The carrier aggregation environment can be referred to as a multiple cell environment. A cell is defined as a combination of a pair of a DL CC and an UL CC, but the UL CC is not an essential element. Therefore, a cell can be composed of downlink resources only or a combination of downlink and uplink resources. In case a particular UE is linked to only one configured serving cell, one DL CC and one UL CC are employed. However, if the particular UE is linked to two or more configured serving cells, as many DL CCs as the number of cells are employed while the number of UL CCs can be equal to or smaller than the number of DL CCs.

Meanwhile, the DL CCs and the UL CCs can be composed in the opposite way. In other words, in case a particular UE is linked to a plurality of configured serving cells, a carrier aggregation environment which has more UL CCs than DL CCs can also be supported. In other words, carrier aggregation can be understood as a combination of two or more cells having different carrier frequencies (center frequencies of the cells). At this time, the term of ‘cell’ should be distinguished from the ‘cell’ usually defined as a region covered by an eNB.

The LTE-A system defines a primary cell (PCell) and a secondary cell (SCell). A PCell and an SCell can be used as a serving cell. A UE being in an RRC CONNECTED state but not being configured for carrier aggregation or not supporting carrier aggregation can be linked to one or more serving cells, and the entire serving cells include a PCell and one or more SCells.

A serving cell (PCell and SCell) can be configured through an RRC parameter. PhysCellId is a physical layer identifier of a cell, having an integer value ranging from 0 to 503. SCellIndex is a short identifier used for identifying an SCell, having an integer value ranging from 1 to 7. ServCellIndex is a short identifier used for identifying a serving cell (PCell or SCell), having an integer value ranging from 0 to 7. The value of 0 is applied to a PCell, and SCellIndex is pre-assigned to be applied to an SCell. In other words, the cell which has the smallest cell ID (or cell index) of ServCellIndex becomes the PCell.

A PCell refers to a cell operating on a primary frequency (or a primary CC). A PCell can be used for an UE to carry out initial connection establishment or connection re-establishment; a PCell may refer to the cell indicated during a handover procedure. Also, a PCell refers to the cell which plays a central role for control-related communication among configured serving cells in a carrier aggregation environment. In other words, a UE is capable of receiving and transmitting a PUCCH only through its own PCell; also, the UE can obtain system information or modify a monitoring procedure only through the PCell. The E-UTRAN (Evolved Universal Terrestrial Radio Access Network) may change only the PCell by using an RRC connection reconfiguration message (RRCConnectionReconfiguration) of an upper layer including mobility control information (mobilityControlInfo) so that the UE supporting carrier aggregation environments can carry out a handout procedure.

An SCell refers to a cell operating on a secondary frequency (or a secondary CC). For a particular UE, only one PCell is allocated, but one or more SCells can be allocated. An SCell can be composed after configuration for an RRC connection is completed and can be used to provide additional radio resources. A PUCCH does not exist in the remaining cells except for PCells among the serving cells configured for a carrier aggregation environment, namely, SCells. When adding an SCell to a UE supporting a carrier aggregation environment, the E-UTRAN can provide all of the system information related to the operation of a cell in the RRC_CONNECTED state through a dedicated signal. Modification of system information can be controlled according to release and addition of a related SCell, and at this time, an RRC connection reconfiguration message (RRCConnectionReconfiguration) message of an upper layer can be used. The E-UTRAN, instead of broadcasting a signal within an SCell, may carry out dedicated signaling using parameters different for each UE.

After the initial security activation process is started, the E-UTRAN may form a network including one or more SCells in addition to a PCell defined in the initial step of a connection establishment process. In a carrier aggregation environment, a PCell and an SCell can operate as an independent component carrier. In the embodiment below, a primary component carrier (PCC) can be used in the same context as the PCell, while a secondary component carrier (SCC) can be used in the same context as the SCell.

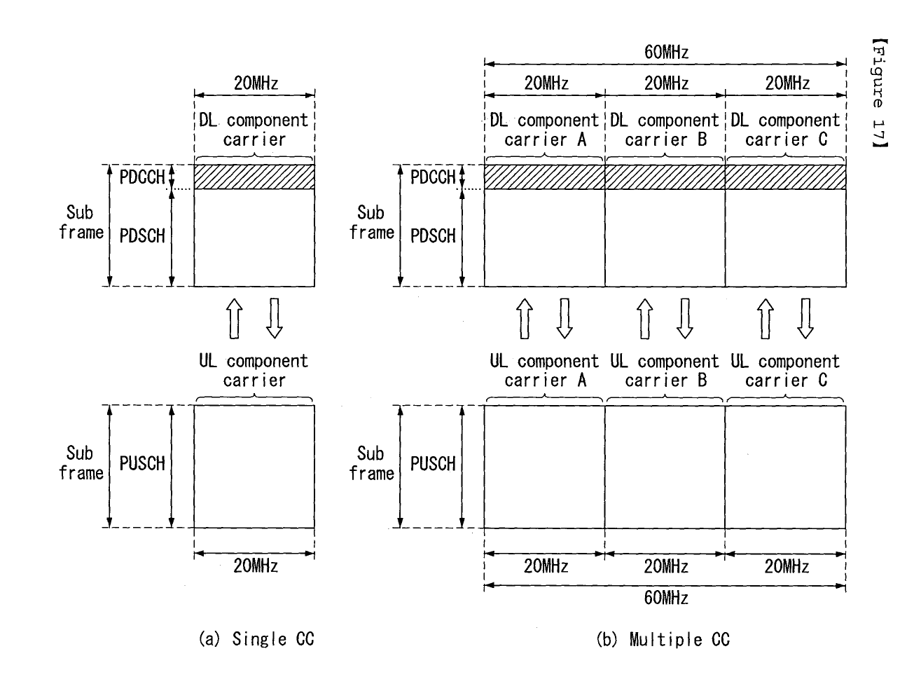

FIG. 17 illustrates one example of a component carrier and carrier aggregation in a wireless communication system to which the present invention can be applied.

FIG. 17(a) shows a single carrier structure defined in the LTE system. Two types of component carriers are used: DL CC and UL CC. A component carrier can have frequency bandwidth of 20 MHz.

FIG. 17(b) shows a carrier aggregation structure used in the LTE A system. FIG. 17(b) shows a case where three component carriers having frequency bandwidth of 20 MHz are aggregated. In this example, 3 DL CCs and 3 UL CCs are employed, but the number of DL CCs and UL CCs is not limited to the example. In the case of carrier aggregation, the UE is capable of monitoring 3 CCs at the same time, capable of receiving a downlink signal/data and transmitting an uplink signal/data.

If a particular cell manages N DL CCs, the network can allocated M (M≦N) DL CCs to the UE. At this time, the UE can monitor only the M DL CCs and receive a DL signal from the M DL CCs. Also, the network can assign priorities for L (L≦M≦N) DL CCs so that primary DL CCs can be allocated to the UE; in this case, the UE has to monitor the L DL CCs. This scheme can be applied the same to uplink transmission.

Linkage between a carrier frequency of downlink resources (or DL CC) and a carrier frequency of uplink resources (or UL CC) can be designated by an upper layer message such as an RRC message or system information. For example, according to the linkage defined by system information block type 2 (SIB2), a combination of DL resources and UL resources can be determined. More specifically, the linkage may refer to a mapping relationship between a DL CC through which a PDCCH carrying an UL grant is transmitted and an UL CC that uses the UL grant; or a mapping relationship between a DL CC (or an UL CC) through which data for HARQ signal are transmitted and an UL CC (or a DL CC) through which a HARQ ACK/NACK signal is transmitted.

Uplink Resource Allocation Procedure

In the case of the 3GPP LTE/LTE-A system, a method for data transmission and reception based on scheduling of an eNB is used to maximize utilization of radio resources. This again implies that in case a UE has data to transmit, the UE requests the eNB to allocate uplink resources in the first place and is capable of transmitting data by using only the uplink resources allocated by the eNB.

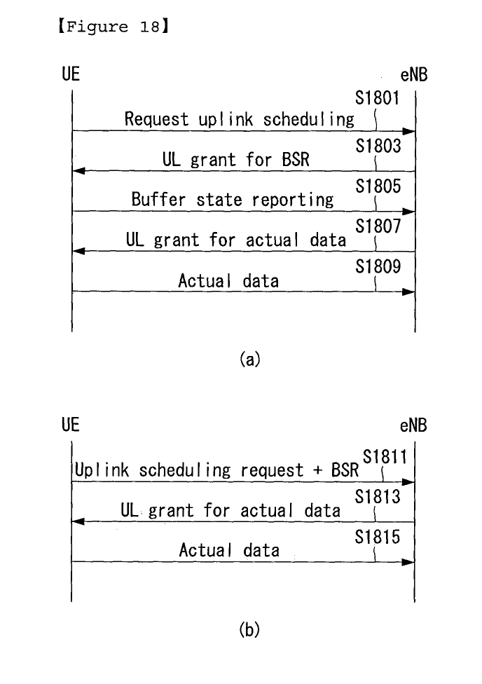

FIG. 18 illustrates an uplink resource allocation process of a UE in a wireless communication system to which the present invention can be applied.

For efficient use of radio resources in uplink transmission, an eNB needs to know which data and how much of the data to transmit to each UE. Therefore, the UE transmits to the eNB the information about uplink data that the UE attempts to transmit directly, and the eNB allocates uplink resources to the corresponding UE in accordance to the UE's transmission. In this case, the information about uplink data that the UE transmits to the eNB is the amount of uplink data stored in the UE's buffer, which is called buffer status report (BSR). When radio resources on the PUSCH are allocated during a current TTI and a reporting event is triggered, the UE transmits the BSR by using the MAC control element.

FIG. 18(a) illustrates an uplink resource allocation process for actual data in case the uplink radio resources for buffer status reporting are not allocated to the UE. In other words, in the case of a UE making a transition from the DRX mode to an active mode, since no data resources are allocated beforehand, the UE has to request resources for uplink data, starting with SR transmission through the PUCCH, and in this case, an uplink resource allocation procedure of five steps is employed.

FIG. 18(a) illustrates the case where the PUSCH resources for transmitting BSR are not allocated to the UE, and the UE first of all transmits a scheduling request (SR) to the eNB to receive PUSCH resources S1801.

The scheduling request is used for the UE to request the eNB to allocate the PUSCH resources for uplink transmission in case radio resources are not scheduled on the PUSCH during a current TTI although a reporting event has occurred. In other words, when a regular BSR has been triggered but uplink radio resources for transmitting the BSR to the eNB are not allocated to the UE, the UE transmits the SR through the PUCCH. Depending on whether the PUCCH resources for SR have been configured, the UE may transmit the SR through the PUCCH or starts a random access procedure. More specifically, the PUCCH resources through the SR can be transmitted are set up by an upper layer (for example, the RRC layer) in a UE-specific manner, and the SR configuration include SR periodicity and SR sub-frame offset information.

If the UE receives from the eNB an UL grant with respect to the PUSCH resources for BSR transmission S1803, the UE transmits the BSR to the eNB, which has been triggered through the PUSCH resources allocated by the UL grant S1805.

By using the BSR, the eNB checks the amount of data for the UE to actually transmit through uplink transmission and transmits to the UE an UL grant with respect to the PUSCH resources for transmission of actual data S1807. The UE, which has received the UL grant meant for transmission of actual data, transmits to the eNB actual uplink data through the allocated PUSCH resources S1809.

FIG. 18(b) illustrates an uplink resource allocation process for actual data in case the uplink radio resources for buffer status reporting are allocated to the UE.

FIG. 18(b) illustrates the case where the PUSCH resources for BSR transmission have already been allocated to the UE; the UE transmits the BSR through the allocated PUSCH resources and transmits a scheduling request to the eNB along with the BSR transmission S1811. Next, by using the BSR, the eNB check the amount of data that the UE actually transmits through uplink transmission and transmits to the UE an UL grant with respect to the PUSCH resources for transmission of actual data S1813. The UE, which has received an UL grant for transmission of actual data, transmits actual uplink data to the eNB through the allocated PUSCH resources S1815.

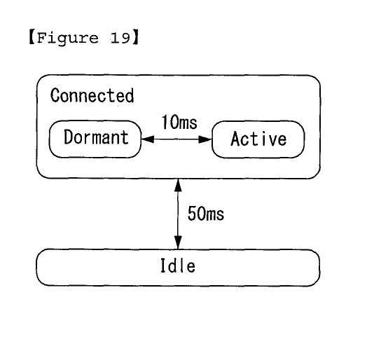

FIG. 19 illustrates latency in a C-plane required in the 3GPP LTE-A system to which the present invention can be applied.

With reference to FIG. 19, the 3GPP LTE-A standard requires that transition time from the IDLE mode (the state where an IP address is assigned) to the connected mode is less than 50 ms. At this time, the transition time includes setting time (which excludes Si transmission delay time) for the user plane (U-Plane). Also, the transition time from the dormant state to the active state within the connected mode is required to be less than 10 ms.

Transition from the dormant state to the active state can be generated according to the following four scenarios.
Uplink initiated transition, synchronized
Uplink initiated transition, unsynchronized
Downlink initiated transition, synchronized
Downlink initiated transition, unsynchronized

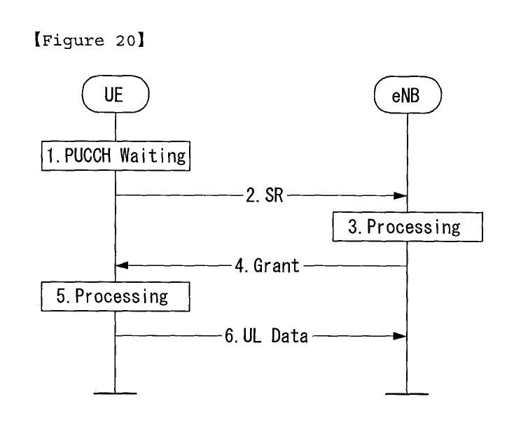

FIG. 20 illustrates transition time of a synchronized UE from a dormant state to an active state required in the 3GPP LTE-A system to which the present invention can be applied.

FIG. 20 illustrates the previous three steps of the uplink resource allocation procedure of FIG. 18 (the case where uplink radio resources for BSR are allocated). In the LTE-A system, delay time as shown in Table 16 is required for uplink resource allocation.

Table 16 shows transition time from the dormant state to the active state initiated by uplink transmission for a synchronized UE, required by the LTE-A system.

TABLE 16

| Component | Description | Time [ms] |
|---|---|---|
| 1 | Average delay to next SR opportunity | 0.5/2.5 |
| | (1 ms/5 ms PUCCH cycle) | |
| 2 | UE sends Scheduling Request | 1 |
| 3 | eNB decodes Scheduling Request and | 3 |
| | generates the Scheduling Grant | |
| 4 | Transmission of Scheduling Grant | 1 |
| 5 | UE Processing Delay (decoding of | 3 |
| | scheduling grant + L1 encoding of UL | |
| | data) | |
| 6 | Transmission of UL data | 1 |
| | Total delay | 9.5/11.5 |

With reference to FIG. 20 and Table 16, an average delay of 0.5 ms/2.5 ms is required due to the PUCCH period having 1 ms/5 ms PUCCH cycle, and 1 ms is required for the UE to transmit SR. And the eNB requires 3 ms to decode the SR and to generate a scheduling grant, and another 1 ms to transmit the scheduling grant. And the UE requires 3 ms to decode the scheduling grant and to encode uplink data in the L1 layer, and another 1 ms to transmit the uplink data.

Thus a total of 9.5/15.5 ms is required for the UE to complete the process of transmitting uplink data.

As described with reference to FIGS. 18 to 20, in the case of uplink data transmission through the uplink resource allocation process of FIG. 18, a scheduling request may cause latency in the UE's transmission of UL data.

In particular, in the case of an application based on intermittent data transmission (for example, health care, traffic safety, and the like) or in the case of an application based on fast data transmission, the uplink data transmission procedure of FIG. 18 may become the cause of latency for data transmission.

Therefore, in what follows, a method for uplink data transmission to reduce latency in the uplink data transmission according to the present invention will be described in detail.

In other words, this document proposes to newly define a PUCCH format for the UE's transmission of (control) information.

In particular, this document defines a PUCCH format for transmitting UL control information of 6 bits or more according to the BSR transmission method described earlier.

More specifically, as a BSR transmission method according to the present invention, (i) a method for reusing the PUCCH format 1/2/3 defined in the current LTE/LTE-A standard and (ii) a method for defining a new PUCCH format 4 will be described.

And a method for allocating PUCCH resources for transmission of a BSR message to each UE or for each UE logical channel ID (LCID) will also be described in association with (i) and (ii).

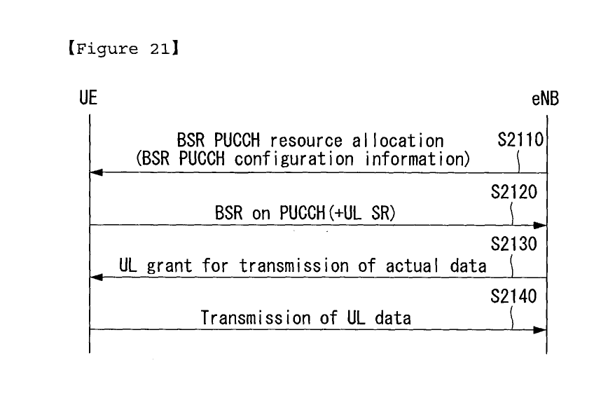

FIG. 21 is a flow diagram illustrating one example of a method for allocating BSR PUCCH resources according to the present invention.

First of all, the eNB allocates to the UE (UL) BSR PUCCH resources for transmission of a BSR message S2110.

The BSR PUCCH resources can be allocated through an RRC message.

The eNB can transmit BSR configuration information element to the UE through UL BSR PUCCH resource allocation of the S2110 step.

The BSR configuration information element represents the information for setting up (or configuring) PUCCH resources for each UE or for each UE logical channel ID (LCID) to perform BSR transmission.

The eNB can perform resource allocation for the UE at the resource set-up step after the UE enters a cell, where the resource allocation is intended for transmitting the BSR configuration information element, namely, UL information of n bits (for example, 6 bits).

The current LTE standard defines that BSR information of 6 bits shall be transmitted, and in what follows, for the convenience of description, it is assumed that a method for transmitting BSR information of 6 bits is used as one example. It should be noted, however, that the present invention can also be applied to transmission of BSR information of variable length other than the 6 bits or transmission of different information.

In other words, the PUCCH format according to the present invention can also be used for transmission of BSR information that can be expressed with a length other than 6 bits. And this again implies that the present invention can be applied in the same way to the information that can be expressed by 3 or 6 symbols through BPSK or QPSK modulation.

The BSR configuration information element includes BSR resource Release, BSR resource Setup, bsr-PUCCH-ResourseIndex, bsr-ConfigIndex, dbsr-TransMax, and bsr-LogicalChIndex.

The BSR resource release field represents release of allocation of UL BSR PUCCH resources.

The BSR resource setup field represents UL BSR PUCCH resource setup.

The bsr-PUCCH-ResourceIndex field represents a resource (in the time domain and/or frequency domain) index with which UL BSR PUCCH resources are allocated.

The bsr-ConfigIndex field represents an index indicating UL BSR PUCCH resource configuration information.

The bsr-TransMax field represents a maximum resource size of UL BSR PUCCH resources.

The bsr-LogicalChIndex field represents a logical channel index related to UL BSR PUCCH resource allocation.

The BSR configuration information element may be transmitted not only during the cell entry process but also during the RRC connection reconfiguration process.

Afterwards, the UE transmits a BSR message to the eNB through the allocated UL BSR PUCCH resources S2120.

In the S2120 step, the UE may transmit an UL scheduling request (SR) to the eNB together with the BSR message.

Then the eNB transmits to the UE an UL grant meant for transmission of actual UL data S2130.

Next, the UE transmits actual UL data to the eNB through an UL grant allocated at the S2130 step S2140.

Since the steps of S2130 and S2140 are the same as the S1807 and the S1809 steps of FIG. 18 or the S1813 and the S1815 steps of FIG. 18, specific descriptions should be referred to FIG. 18.

UL BSR PUCCH format

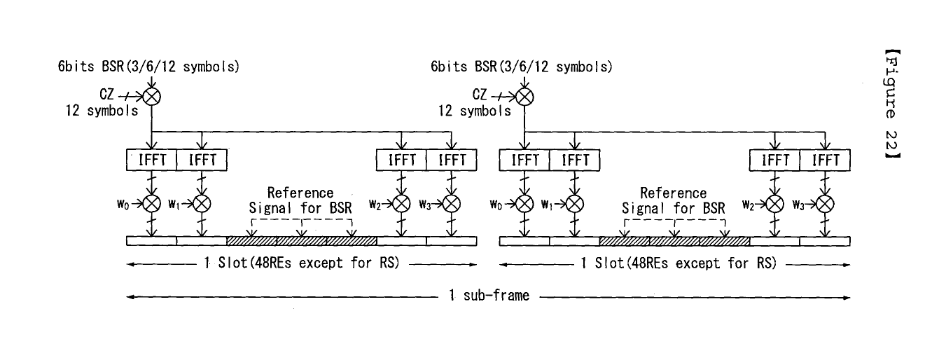

In what follows, a PUCCH resource format (or structure) meant for transmission of an UL BSR message in the S2110 and the S2120 steps will be described in detail with reference to FIGS. 22 to 51.

As described above, the new UL BSR PUCCH format according to the present invention can be defined to transmit information consisting of more than 3 bits such as CQI, HARQ A/N, and SR to a PUCCH.

A method for transmitting information through a physical control channel is intended to carry out a procedure of the UE a little faster by allocating particular resources (short information consisting of 1 or 2 bits) to the UE beforehand.

For the current UE procedure, to carry out more quickly an SR procedure which causes a long delay in particular, a PUCCH capable of transmitting n bit BSR information instead of 1 bit SR information is designed, and a format meant for the PUCCH is proposed.

At this time, for the n bit BSR information, 6 bits can be used to accommodate the 6 bit BSR message defined in the current LTE/LTE-A standard; however, the n bit BSR information may be extended to a format that can be used for transmission of information with a length other than the specific bit length.

In other words, the UL PUCCH formation according to the present invention can be used for the information with a length Nᵢ₊₁=2*Nᵢ bits (N₀=3, 0≦i≦6 and N₀=36, 0≦i≦3), and the corresponding N bits indicates that the N symbols or N/2 symbols information generated through BPSK or QPSK modulation can be mapped to an RE through IFFT.

In other words, the present invention proposes a new UL PUCCH format intended for transmission of information consisting of 3/6/12/24/48/96/192(in case 0≦i≦6) and 36/72/144/288 (in case 0≦i≦3) bits.

Also, an orthogonal cover sequence employed in the UL PUCCH according to the present invention [w0, w1, . . . , wn] can be applied directly by a DFT matrix equation depending on the n value.

First, a method for defining a new PUCCH format for transmission of UL data or UL control information based on redefinition of a PUCCH format 1 will be described.

In what follows, for the convenience of description, an UL BSR message is taken as one example of the UL data or the UL control information. However, the present invention is not limited to the example above and can be applied for transmission of various types of information.

FIGS. 22 to 24 illustrate examples of a PUCCH structure capable of multiplexing UL BSR messages by using an orthogonal cover sequence of length 4.

In other words, in FIGS. 22 to 24, an N symbol BSR message is spread in the frequency domain and/or in the time domain through a CZ sequence of length M and/or an orthogonal cover sequence of length 4, forming a PUCCH format (or structure) to distinguish a total of M*4 UL BSR messages.

At this time, the CZ sequence may be a ZC (Zadoff-Chu) sequence, and the orthogonal cover sequence may be a Hadamard sequence.

FIG. 22 illustrates one example of an uplink physical control channel format according to the present invention.

FIG. 22 redefines the PUCCH format 1, providing one example of a new PUCCH format for UL BSR transmission.

As shown in FIG. 22, N symbol BSR messages are transmitted repeatedly from each slot through two slots.

More specifically, for each slot, the N symbol BSR message generates 12 symbols through a CZ sequence of length M, and the 12 symbols are mapped to (or carried by) the remaining four symbols except for three RS symbols through 4 IFFT modules and an orthogonal cover sequence of length 4 so that the 12 symbols can be mapped to 48 REs.

The CZ sequence of length M can have M cyclic shift values (0, 1, 2, . . . , M−1) different from each other.

At this time, each slot or symbol within a subframe can be expressed by an SC-FDMA symbol.

As shown in FIG. 22, the signal output through each IFFT module is mapped to each slot or symbol of the subframe through the orthogonal cover sequence of length 4.

It should be noted that the number of UL BSR messages that can be identified from each other can be determined according to the length (M) of a CZ sequence and the length (4) of an orthogonal cover sequence. In other words, the total number of identifiable UL BSR messages is 4M.

Also, the length of a CZ sequence can be determined by N so that an N symbol BSR message can generate 12 symbols within one slot.

At this time, the N symbols represent complex valued symbols generated through BPSK or QPSK modulation.

For example, in case N is 3, the length of a CZ sequence becomes 4.

In this case, the total number of identifiable UL BSRs becomes 16 (4*4).

In case N is 6, the length of a CZ sequence becomes 2.

In this case, the total number of identifiable UL BSRs can be 8.

In case N is 12, a CZ sequence is not applied, but a total of four UL BSR messages can be identified from each other through an orthogonal cover sequence of length 4.

At this time, a 3 symbols BSR message is generated from a 3 bit BSR message through BPSK modulation or from a 6 bit BSR message through QPSK modulation.

Also, a 6 symbols BSR message is generated from a 6 bit BSR through BPSK modulation or from a 12 bit BSR message through QPSK modulation.

Similarly, a 12 symbols BSR message is generated from a 12 bit BSR message through BPSK modulation or from a 24 bit BSR message through QPSK modulation.

Table 17 shows one example of an orthogonal cover sequence of length 4 according to the present invention.

TABLE 17

| Seq. | Orthogonal Seq. |
|---|---|
| index | [W₀, W₁, W₂, W₃] |
| 0 | [+1, +1, +1, +1] |
| 1 | [+1, −1, +1, −1] |
| 2 | [+1, −1, −1, +1] |
| 3 | N/A |

To summarize, the UL BSR PUCCH format (or structure) of FIG. 22 can be applied to multiplexing of 4M different UEs or 4M different control channels involved in UL BSR transmission through a CZ sequence of length M and/or through an orthogonal cover sequence of length 4.

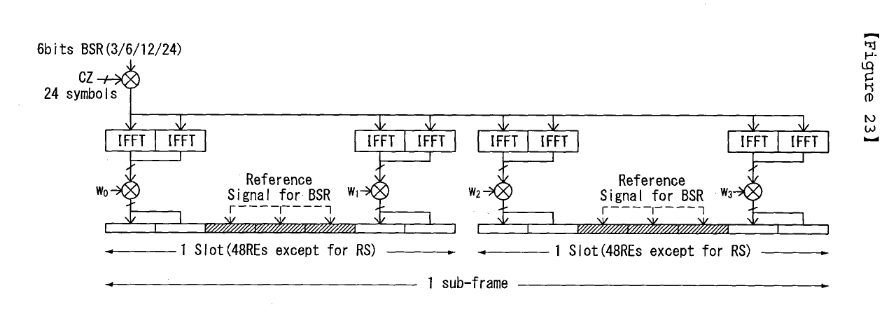

FIG. 23 illustrates another example of the uplink physical control channel format according to the present invention.

FIG. 23 illustrates a PUCCH format meant for transmitting an N symbol BSR message through one subframe only for once.

With reference to FIG. 23, for each subframe, an N symbol BSR message generates 24 symbols through a CZ sequence of length M, and the 24 symbols are mapped to (or carried by) 8 symbols except for 6 RS symbols (4 symbols excluding 3 RS symbols for each slot) through 8 IFFT modules (4 IFFT modules for each slot) and an orthogonal cover sequence of length 4 so that the 24 symbols can be mapped to 96 REs (48 REs for each slot).

The number of identifiable UL BSR messages can be determined according to the length (M) of a CZ sequence and the length (4) of an orthogonal cover sequence. In other words, the total number of identifiable UL BSRs is 4M.

Also, the length of a CZ sequence can be determined by N so that an N symbol BSR message can generate 24 symbols for each subframe.

At this time, the N symbols represent complex valued symbols generated through BPSK or QPSK modulation.

For example, in case N is 3, the length of a CZ sequence becomes 8, and the total number of UL BSRs identified by the CZ sequence can be 32 (=8*4).

In case N is 6, the length of a CZ sequence becomes 4, and the total number of identifiable UL BSR messages becomes 16.

In case N is 24, a CZ sequence is not applied, and a total of 4 UL BSR messages can be identified through an orthogonal cover sequence of length 4.

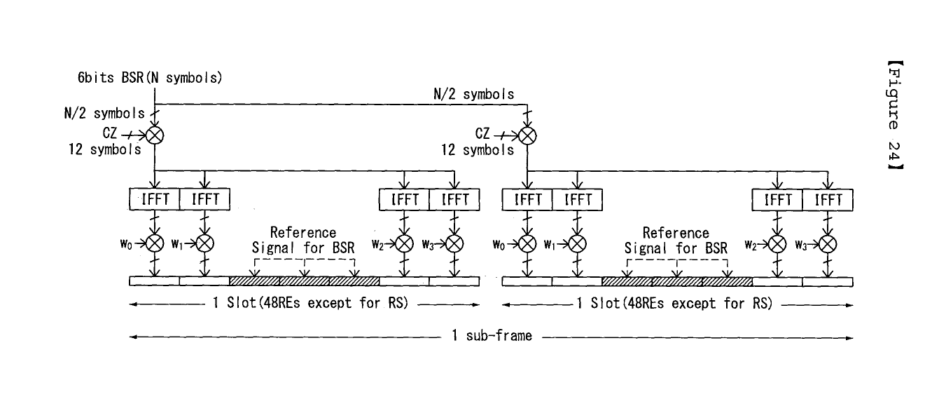

FIG. 24 illustrates another example of the uplink physical control channel format according to the present invention.

FIG. 24 illustrates a PUCCH format meant for transmitting an N symbol BSR message through one subframe only for once.

With reference to FIG. 24, one half (N/2 symbols) of an N symbol BSR message are input to each slot.

In other words, an N/2 symbol BSR message generates 12 symbols for each slot through a CZ sequence of length M, and the 12 symbols are mapped to (or carried by) 4 symbols except for 3 RS symbols through 4 IFFT modules and an orthogonal cover sequence of length 4 so that the 12 symbols can be mapped to 48 REs for each slot.

At this time, the number of identifiable UL BSR messages can be determined by the length (M) of a CZ sequence and the length (4) of an orthogonal cover sequence.

In the case of FIG. 24, since an UL BSR message can be identified for each slot according to the length of a CZ sequence and the length of an orthogonal cover sequence, a total number of identifiable UL BSR messages becomes 4M (M*2*2).

Also, the length of a CZ sequence can be determined by N/2 so that an N/2 symbol BSR message can generate 12 symbols for each slot.

For example, in case N is 6, the length of a CZ sequence becomes 2, and a total number of UL BSR messages that can be identified through one subframe can be 16 (8 for each slot).

In case N is 12, a CZ sequence is not applied, and only the orthogonal cover sequence of length 4 can be applied; therefore, a total of 8 UL BSR messages can be identified through one subframe.

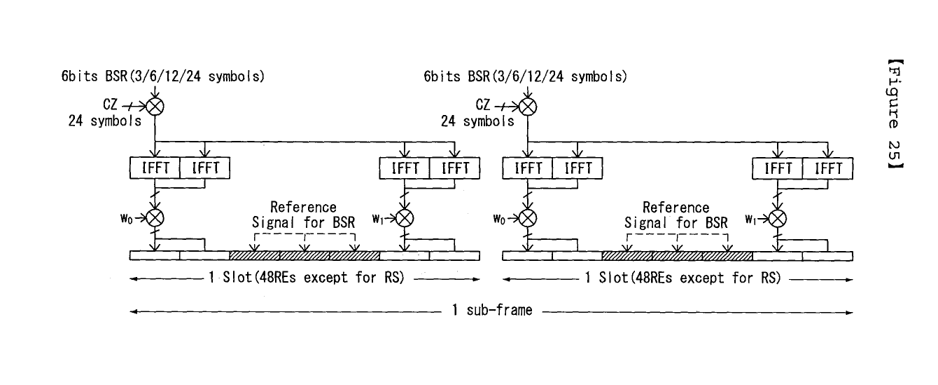

FIGS. 25 to 27 illustrate examples of a PUCCH structure for identifying a plurality of UL BSR messages by using an orthogonal cover sequence of length 2.

In other words, FIGS. 25 to 27 illustrate examples of a PUCCH format (or structure) for distinguishing a total of M*2 UL BSR messages by multi-spreading of an N symbol BSR message into the frequency domain and/or time domain through a CZ sequence of length M and/or an orthogonal cover sequence of length 2 within one subframe.

At this time, the CZ sequence may correspond to a Zadoff-Chu (ZC) sequence, and the orthogonal cover sequence may be a Hadamard sequence.

FIG. 25 illustrates another example of an uplink physical control channel format according to the present invention.

FIG. 25 shows a PUCCH format meant for transmitting an N symbol BSR message repeatedly from each of two slots.

With reference to FIG. 25, an N symbol BSR message generates 24 symbols for each slot through a CZ sequence of length M, and the 24 symbols are mapped to (or carried by) 4 symbols except for 3 RS symbols through 4 IFFT modules and an orthogonal cover sequence of length 2 so that the 24 symbols can be mapped to 48 REs.

At this time, a symbol within a slot or a subframe can be expressed by an SC-FDMA symbol.

As shown in FIG. 25, every two IFFT modules are mapped to two consecutive symbols through an orthogonal cover sequence of length 2.

At this time, the number of identifiable UL BSR messages can be determined by the length (M) of a CZ sequence and the length (2) of an orthogonal cover sequence. In other words, a total number of identifiable UL BSR messages becomes 2M.

Also, the length of a CZ sequence can be determined by N so that an N symbol BSR message can generate 24 symbols within one slot.

At this time, the N symbols represent complex valued symbols generated through BPSK or QPSK modulation.

For example, in case N is 3, the length of a CZ sequence is 8, and a total number of UL BSR messages that can be identified through the CZ sequence becomes 16.

In case N is 6, the length of a CZ sequence is 4, and a total number of identifiable UL BSR messages can be 8.

In case N is 24, a CZ sequence is not applied, but a total of 2 UL BSR messages can be identified through an orthogonal cover sequence of length 2.

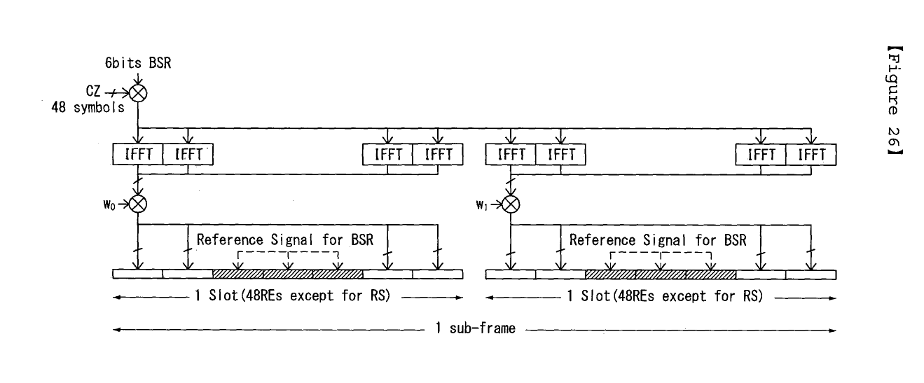

FIG. 26 illustrates another example of an uplink physical control channel format according to the present invention.

FIG. 26 illustrates a PUCCH format meant for transmitting an N symbol BSR message through one subframe only for once.

With reference to FIG. 26, for each subframe, an N symbol BSR message generates 48 symbols through a CZ sequence of length M, and the 48 symbols are mapped to (or carried by) 8 symbols except for 6 RS symbols (4 symbols excluding 3 RS symbols for each slot) through 8 IFFT modules (4 IFFT modules for each slot) and an orthogonal cover sequence of length 2 so that the 24 symbols can be mapped to 96 REs.

In the same way, the number of identifiable UL BSR messages can be determined according to the length (M) of a CZ sequence and the length (2) of an orthogonal cover sequence. In other words, the total number of identifiable UL BSRs is 2M.

Also, the length of a CZ sequence can be determined by N so that an N symbol BSR message can generate 48 symbols for each subframe.

At this time, the N symbols represent complex valued symbols generated through BPSK or QPSK modulation.

For example, in case N is 3, the length of a CZ sequence becomes 16, and the total number of UL BSRs identified by the CZ sequence can be 32.

In case N is 6, the length of a CZ sequence becomes 8, and the total number of identifiable UL BSR messages becomes 16.

In case N is 48, a CZ sequence is not applied, but a total of 2 UL BSR messages can be identified through an orthogonal cover sequence of length 2.

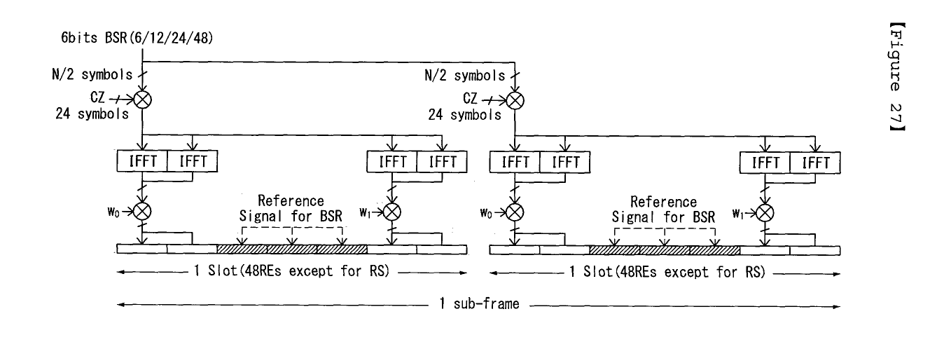

FIG. 27 illustrates another example of the uplink physical control channel format according to the present invention.

FIG. 27 illustrates a PUCCH format meant for transmitting an N symbol BSR message through one subframe only for once.

With reference to FIG. 27, one half (N/2 symbols) of an N symbol BSR message are input to each slot.

In other words, an N/2 symbol BSR message generates 24 symbols for each slot through a CZ sequence of length M, and the 24 symbols are mapped to (or carried by) 4 symbols except for 3 RS symbols through 4 IFFT modules and an orthogonal cover sequence of length 2 so that the 12 symbols can be mapped to 48 REs for each slot.

At this time, the number of identifiable UL BSR messages can be determined by the length (M) of a CZ sequence and the length (4) of an orthogonal cover sequence.

As shown in FIG. 27, every two IFFT modules are mapped to two consecutive symbols through an orthogonal cover sequence of length 2.

In this case, the number of identifiable UL BSR messages can be determined by the length (M) of a CZ sequence and the length (2) of an orthogonal cover sequence.

In the case of FIG. 27, since an UL BSR message can be identified for each slot according to the length of a CZ sequence and the length of an orthogonal cover sequence, a total number of identifiable UL BSR messages becomes 4M (M*2*2).

Also, the length of a CZ sequence can be determined by N/2 so that an N/2 symbol BSR message can generate 24 symbols for each slot.

For example, in case N is 6, the length of a CZ sequence becomes 8, and a total number of UL BSR messages that can be identified through one subframe can be 32 (16 for each slot).

In case N is 12, the length of a CZ sequence becomes 4, and a total number of UL BSR messages that can be identified through one subframe can be 16 (8 for each slot).

In case N is 48, a CZ sequence is not applied, and only the orthogonal cover sequence of length 2 can be applied; therefore, a total of 4 UL BSR messages can be identified through one subframe.

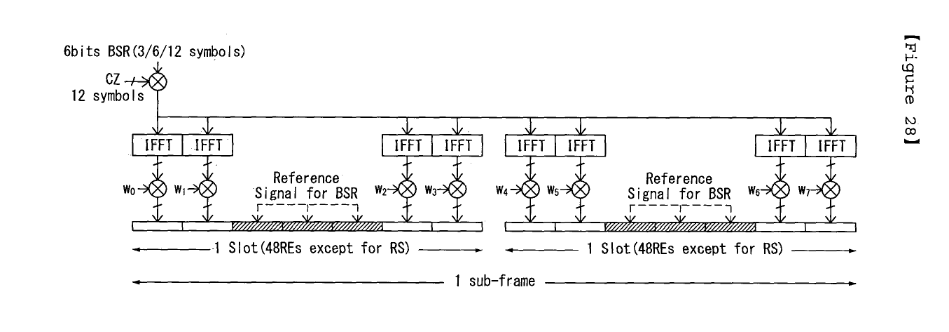

FIG. 28 illustrates another example of a PUCCH structure for identifying a plurality of UL BSR messages by using an orthogonal cover sequence of length 8.

In other words, FIG. 28 illustrates an example of a PUCCH format (or structure) for distinguishing a total of M*8 UL BSR messages by multi-spreading of an N symbol BSR message into the frequency domain and/or time domain through a CZ sequence of length M and/or an orthogonal cover sequence of length 8 within one subframe.

FIG. 28 illustrates a PUCCH format meant for transmitting an N symbol BSR message through one subframe only for once.

With reference to FIG. 28, for each subframe, an N symbol BSR message generates 12 symbols through a CZ sequence of length M, and the 12 symbols are mapped to (or carried by) 8 symbols except for 6 RS symbols (4 symbols excluding 3 RS symbols for each slot) through 8 IFFT modules (4 IFFT modules for each slot) and an orthogonal cover sequence of length 8 so that the 12 symbols can be mapped to 96 REs.

At this time, the number of identifiable UL BSR messages can be determined according to the length (M) of a CZ sequence and the length (8) of an orthogonal cover sequence. In other words, the total number of identifiable UL BSRs is 8M.

Also, the length of a CZ sequence can be determined by N so that an N symbol BSR message can generate 12 symbols for each subframe.

At this time, the N symbols represent complex valued symbols generated through BPSK or QPSK modulation.

For example, in case N is 3, the length of a CZ sequence becomes 4, and the total number of UL BSRs identified by the CZ sequence can be 32 (4*8).

In case N is 6, the length of a CZ sequence becomes 2, and the total number of identifiable UL BSR messages becomes 16.

In case N is 12, a CZ sequence is not applied, and a total of 8 UL BSR messages can be identified through an orthogonal cover sequence of length 8.

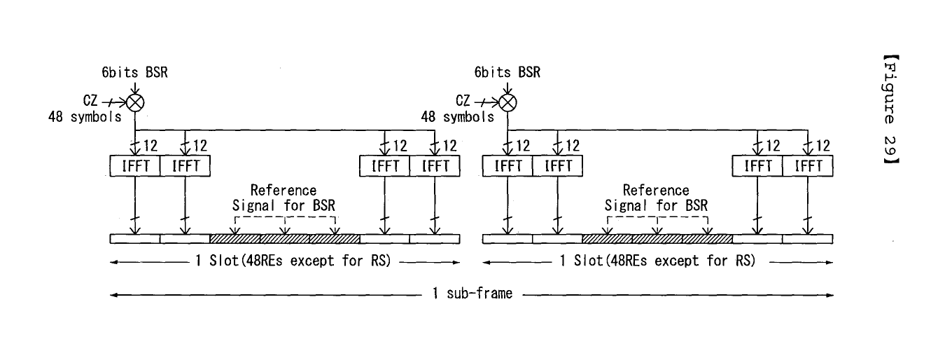

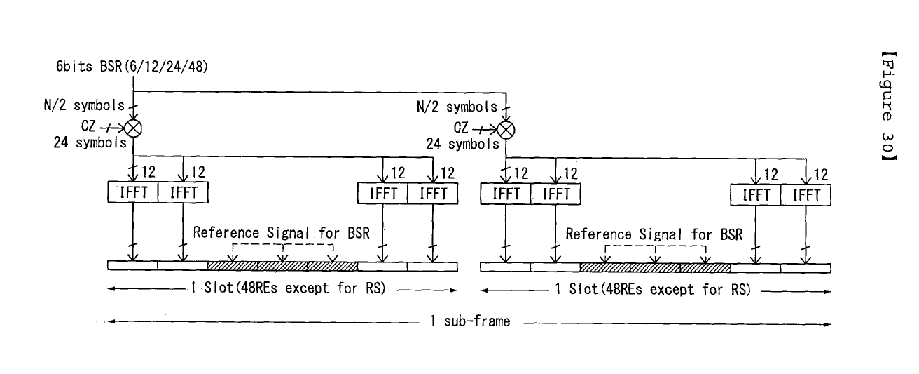

FIGS. 29 to 30 illustrate examples of a PUCCH structure for identifying multiple UL BSR messages without using an orthogonal cover sequence.

In other words, FIGS. 29 to 30 illustrate examples of a PUCCH format (or structure) for distinguishing a total of M UL BSR messages by multi-spreading of an N symbol BSR message into the frequency domain through a CZ sequence of length M within one subframe.

FIG. 29 illustrates another example of an uplink physical control channel format according to the present invention.

FIG. 29 shows a PUCCH format meant for transmitting an N symbol BSR message repeatedly from each of two slots.

With reference to FIG. 29, an N symbol BSR message generates 48 symbols for each slot through a CZ sequence of length M, and the 48 symbols are mapped to (or carried by) 4 symbols except for 3 RS symbols through 4 IFFT modules for each slot so that the 48 symbols can be mapped to 48 REs.

At this time, a symbol within a slot or a subframe can be expressed by an SC-FDMA symbol.

As shown in FIG. 29, a signal output from each IFFT module is mapped to the corresponding symbol within a slot.

Also, the figure shows that 12 symbols are input to each IFFT module.

In this case, the number of identifiable UL BSR messages can be determined according to the length (M) of a CZ sequence. Therefore, a total number of identifiable UL BSR messages becomes M.

Also, the length of a CZ sequence can be determined by N so that an N symbol BSR message can generate 48 symbols within one slot.

At this time, the N symbols represent complex valued symbols generated through BPSK or QPSK modulation.

For example, in case N is 3, the length of a CZ sequence is 16, and a total number of UL BSR messages that can be identified through the CZ sequence becomes 16.

In case N is 6, the length of a CZ sequence is 8, and a total number of identifiable UL BSR messages can be 8.

In case N is 48, a CZ sequence is not applied; thus only one UL BSR message can be identified.

FIG. 30 illustrates another example of an uplink physical control channel format according to the present invention.

FIG. 30 illustrates a PUCCH format meant for transmitting an N symbol BSR message through one subframe only for once.

With reference to FIG. 30, one half (N/2 symbols) of an N symbol BSR message are input to each slot.

In other words, an N/2 symbol BSR message generates 24 symbols for each slot through a CZ sequence of length M, and the 24 symbols are mapped to (or carried by) 4 symbols except for 3 RS symbols through 4 IFFT modules so that the 24 symbols can be mapped to 48 REs for each slot.

As shown in FIG. 30, a signal output from each IFFT module is mapped to the corresponding symbol within a slot.

Also, the figure shows that 12 symbols are input to each IFFT module.

In this case, the number of identifiable UL BSR messages can be determined according to the length (M) of a CZ sequence.

Therefore, a total number of identifiable UL BSR messages becomes M.

Also, the length of a CZ sequence can be determined by N/2 so that an N/2 symbol BSR message can generate 24 symbols within one slot.

For example, in case N is 6, the length of a CZ sequence is 8, and a total number of UL BSR messages that can be identified within one subframe through the CZ sequence becomes 4.

In case N is 12, the length of a CZ sequence is 4, and a total number of identifiable UL BSR messages can be 4.

In case N is 48, a CZ sequence is not applied; thus only one UL BSR message can be identified.

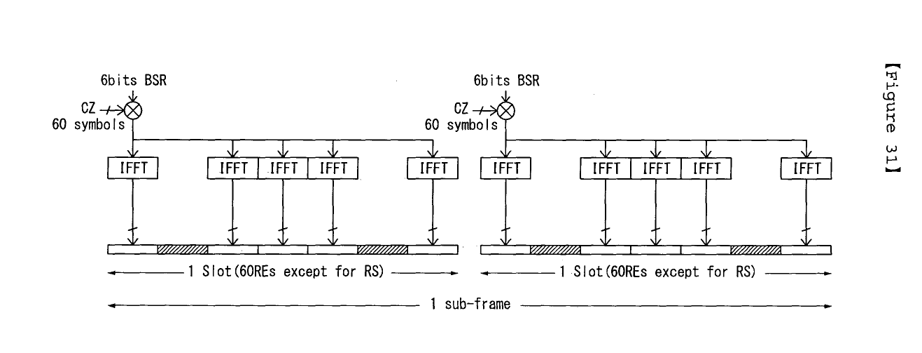

Next, a method for defining a new PUCCH format for transmission of an UL BSR message based on redefinition of a PUCCH format 2 will be described in detail with reference to FIGS. 31 to 37.

FIGS. 31 to 33 illustrate examples of a PUCCH structure for identifying multiple UL BSR messages without using an orthogonal cover sequence.

In other words, FIGS. 31 to 33 illustrate examples of a PUCCH format (or structure) for distinguishing a total of M UL BSR messages by multi-spreading of an N symbol BSR message into the frequency domain through a CZ sequence of length M within one subframe.

FIG. 31 illustrates another example of an uplink physical control channel format according to the present invention.

FIG. 31 shows a PUCCH format meant for transmitting an N symbol BSR message repeatedly from each of two slots.

With reference to FIG. 31, an N symbol BSR message generates 60 symbols for each slot through a CZ sequence of length M, and the 60 symbols are mapped to (or carried by) 5 symbols except for 2 RS symbols through 5 IFFT modules for each slot so that the 60 symbols can be mapped to 60 REs.

At this time, a symbol within a slot or a subframe can be expressed by an SC-FDMA symbol.

As shown in FIG. 31, a signal output from each IFFT module is mapped to the corresponding symbol within a slot.

In this case, the number of identifiable UL BSR messages can be determined by the length (M) of a CZ sequence. Therefore, a total number of identifiable UL BSR messages becomes M.

Also, the length of a CZ sequence can be determined by N so that an N symbol BSR message can generate 60 symbols within one slot.

At this time, the N symbols represent complex valued symbols generated through BPSK or QPSK modulation.

For example, in case N is 3, the length of a CZ sequence is 20, and a total number of UL BSR messages that can be identified through the CZ sequence becomes 20.

In case N is 6, the length of a CZ sequence is 6, and a total number of identifiable UL BSR messages can be 10.

In case N is 12, the length of a CZ sequence is 5, and a total number of identifiable UL BSR messages can be 5.

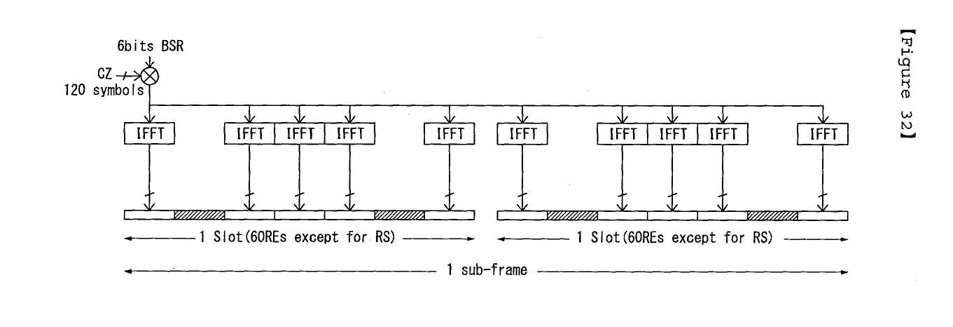

FIG. 32 illustrates another example of an uplink physical control channel format according to the present invention.

FIG. 32 illustrates a PUCCH format meant for transmitting an N symbol BSR message through one subframe only for once.

With reference to FIG. 32, for each subframe, an N symbol BSR message generates 120 symbols through a CZ sequence of length M, and the 120 symbols are mapped to (or carried by) 10 symbols except for 4 RS symbols (5 symbols excluding 2 RS symbols for each slot) through 8 IFFT modules (4 IFFT modules for each slot) so that the 120 symbols can be mapped to 120 REs (60 REs for each slot).

At this time, the number of identifiable UL BSR messages can be determined according to the length (M) of a CZ sequence. In other words, the total number of identifiable UL BSRs is M.

Also, the length of a CZ sequence can be determined by N so that an N symbol BSR message can generate 120 symbols for each subframe.

At this time, the N symbols represent complex valued symbols generated through BPSK or QPSK modulation.

For example, in case N is 3, the length of a CZ sequence becomes 40, and the total number of UL BSRs identified by the CZ sequence can be 40.

In case N is 6, the length of a CZ sequence becomes 20, and the total number of identifiable UL BSR messages becomes 20.

In case N is 12, the length of a CZ sequence becomes 10, and the total number of identifiable UL BSR messages becomes 10.

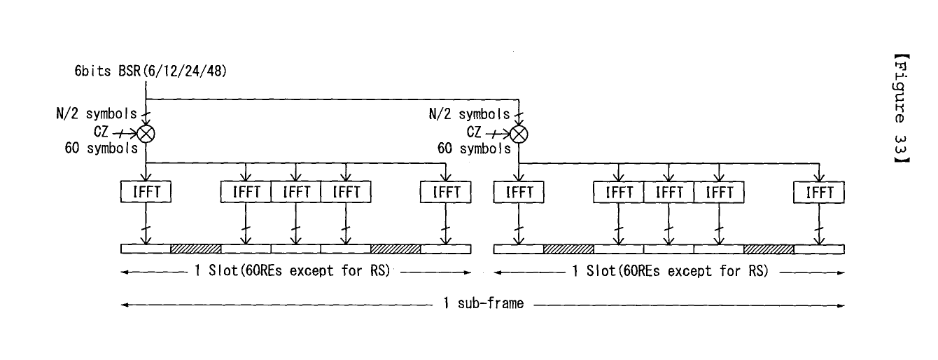

FIG. 33 illustrates another example of the uplink physical control channel format according to the present invention.

FIG. 33 illustrates a PUCCH format meant for transmitting an N symbol BSR message through one subframe only for once.

With reference to FIG. 33, one half (N/2 symbols) of an N symbol BSR message are input to each slot.

In other words, an N/2 symbol BSR message generates 60 symbols for each slot through a CZ sequence of length M, and the 60 symbols are mapped to (or carried by) 5 symbols except for 2 RS symbols through 5 IFFT modules so that the 60 symbols can be mapped to 60 REs for each slot.

As shown in FIG. 33, a signal output from each IFFT module is mapped to the corresponding symbol within a slot

In this case, the number of identifiable UL BSR messages can be determined by the length (M) of a CZ sequence.

In other words, a total number of identifiable UL BSR messages becomes M.

Also, the length of a CZ sequence can be determined by N/2 so that an N/2 symbol BSR message can generate 60 symbols for each slot.

For example, in case N is 6, the length of a CZ sequence becomes 20, and a total number of UL BSR messages that can be identified through one subframe can be 20.

In case N is 12, the length of a CZ sequence becomes 10, and a total number of UL BSR messages that can be identified through one subframe can be 10.

In case N is 24, the length of a CZ sequence becomes 5, and a total number of UL BSR messages that can be identified through one subframe can be 5.

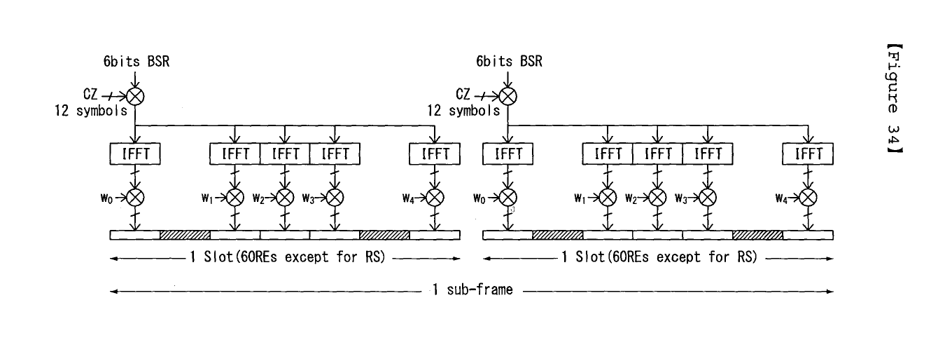

FIGS. 34 to 36 illustrate examples of a PUCCH structure for identifying a plurality of UL BSR messages by using an orthogonal cover sequence of length 5.

In other words, FIGS. 34 to 36 illustrate examples of a PUCCH format (or structure) for distinguishing a total of M*5 UL BSR messages by multi-spreading of an N symbol BSR message into the frequency domain and/or time domain through a CZ sequence of length M and/or an orthogonal cover sequence of length 5 within one subframe.

At this time, the CZ sequence may correspond to a Zadoff-Chu (ZC) sequence, and the orthogonal cover sequence may be a Hadamard sequence.

FIG. 34 illustrates another example of an uplink physical control channel format according to the present invention.

FIG. 34 shows a PUCCH format meant for transmitting an N symbol BSR message repeatedly from each of two slots.

With reference to FIG. 34, an N symbol BSR message generates 12 symbols for each slot through a CZ sequence of length M, and the 12 symbols are mapped to (or carried by) 5 symbols except for 2 RS symbols through 5 IFFT modules and an orthogonal cover sequence of length 5 so that the 12 symbols can be mapped to 60 REs for each slot.

At this time, a symbol within a slot or a subframe can be expressed by an SC-FDMA symbol.

At this time, the number of identifiable UL BSR messages can be determined by the length (M) of a CZ sequence and the length (5) of an orthogonal cover sequence.

In other words, a total number of identifiable UL BSR messages becomes 5M.

Also, the length of a CZ sequence can be determined by N so that an N symbol BSR message can generate 12 symbols within one slot.

At this time, the N symbols represent complex valued symbols generated through BPSK or QPSK modulation.

For example, in case N is 3, the length of a CZ sequence is 4, and a total number of UL BSR messages that can be identified through the CZ sequence becomes 20 (4*5).

In case N is 6, the length of a CZ sequence is 2, and a total number of identifiable UL BSR messages can be 10.

In case N is 12, a CZ sequence is not applied, but a total of 5 UL BSR messages can be identified through an orthogonal cover sequence of length 5.

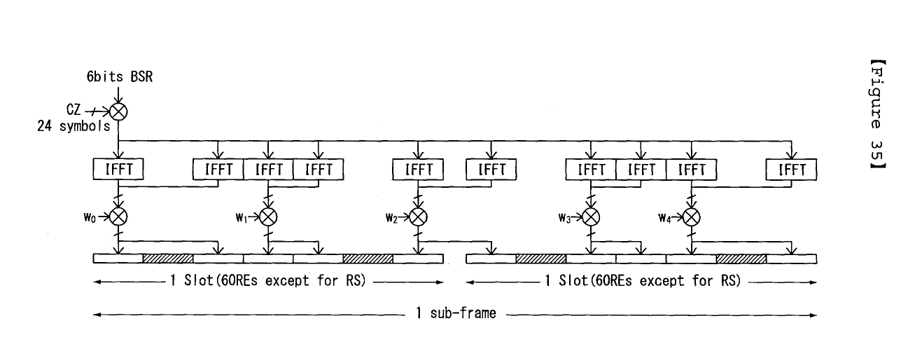

FIG. 35 illustrates another example of an uplink physical control channel format according to the present invention.

FIG. 35 illustrates a PUCCH format meant for transmitting an N symbol BSR message through one subframe only for once.

With reference to FIG. 35, for each subframe, an N symbol BSR message generates 24 symbols through a CZ sequence of length M, and the 24 symbols are mapped to (or carried by) 10 symbols except for 4 RS symbols (5 symbols excluding 2 RS symbols for each slot) through 10 IFFT modules (5 IFFT modules for each slot) and an orthogonal cover sequence of length 5 so that the 24 symbols can be mapped to 120 REs (60 REs for each slot).

In the same way, the number of identifiable UL BSR messages can be determined according to the length (M) of a CZ sequence and the length (5) of an orthogonal cover sequence. In other words, the total number of identifiable UL BSRs is 5M.

Also, the length of a CZ sequence can be determined by N so that an N symbol BSR message can generate 24 symbols for each subframe.

At this time, the N symbols represent complex valued symbols generated through BPSK or QPSK modulation.

For example, in case N is 3, the length of a CZ sequence becomes 8, and the total number of UL BSRs identified by the CZ sequence can be 40 (8*5).

In case N is 6, the length of a CZ sequence becomes 4, and the total number of identifiable UL BSR messages becomes 20.

In case N is 24, a CZ sequence is not applied, but a total of 5 UL BSR messages can be identified through an orthogonal cover sequence of length 5.

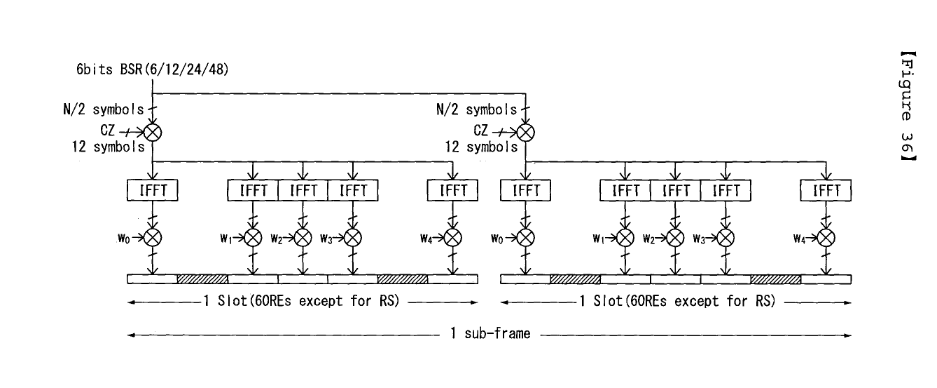

FIG. 36 illustrates another example of the uplink physical control channel format according to the present invention.

FIG. 36 illustrates a PUCCH format meant for transmitting an N symbol BSR message through one subframe only for once.

With reference to FIG. 36, one half (N/2 symbols) of an N symbol BSR message are input to each slot.

In other words, an N/2 symbol BSR message generates 12 symbols for each slot through a CZ sequence of length M, and the 12 symbols are mapped to (or carried by) 5 symbols except for 2 RS symbols through 5 IFFT modules and an orthogonal cover sequence of length 5 so that the 12 symbols can be mapped to 60 REs for each slot.

As shown in FIG. 36, a signal output from each IFFT module is mapped to the corresponding symbol within a slot through an orthogonal cover sequence of length 5.

In this case, the number of identifiable UL BSR messages can be determined by the length (M) of a CZ sequence and the length (5) of an orthogonal cover sequence.

In other words, a total number of identifiable UL BSR messages becomes 5M.

Also, the length of a CZ sequence can be determined by N/2 so that an N/2 symbol BSR message can generate 12 symbols for each slot.

For example, in case N is 6, the length of a CZ sequence becomes 4, and a total number of UL BSR messages that can be identified through one subframe can be 20 (4*5).

In case N is 12, the length of a CZ sequence becomes 2, and a total number of UL BSR messages that can be identified through one subframe can be 10.

In case N is 24, a CZ sequence is not applied, but a total of 5 UL BSR messages can be identified through one subframe as only the orthogonal cover sequence of length 5 is employed.

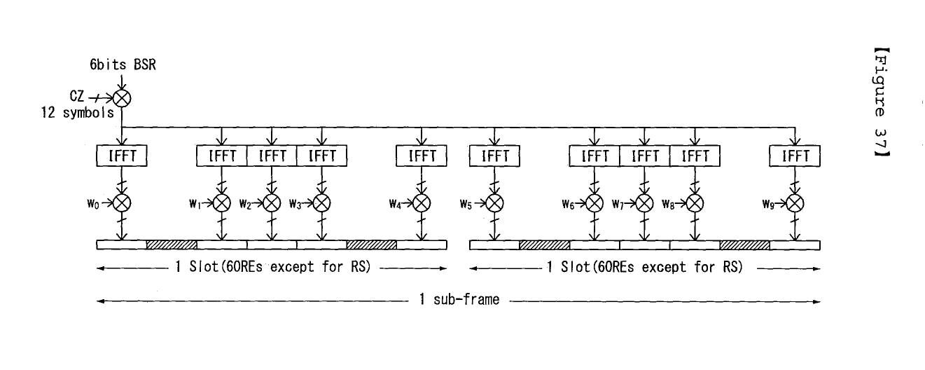

FIG. 37 illustrates another example of an uplink physical control channel format according to the present invention.

FIG. 37 illustrates an example of a PUCCH structure for identifying a plurality of UL BSR messages by using an orthogonal cover sequence of length 10.

In other words, FIG. 37 illustrates one example of a PUCCH format (or structure) for distinguishing a total of M*10 UL BSR messages by multi-spreading of an N symbol BSR message into the frequency domain and/or time domain through a CZ sequence of length M and/or an orthogonal cover sequence of length 10 within one subframe.

FIG. 37 illustrates a PUCCH format meant for transmitting an N symbol BSR message through one subframe only for once.

With reference to FIG. 37, for each subframe, an N symbol BSR message generates 12 symbols through a CZ sequence of length M, and the 12 symbols are mapped to (or carried by) 10 symbols except for 4 RS symbols (5 symbols excluding 2 RS symbols for each slot) through 10 IFFT modules (4 IFFT modules for each slot) and an orthogonal cover sequence of length 8 so that the 12 symbols can be mapped to 120 REs (60 REs for each slot).

At this time, the number of identifiable UL BSR messages can be determined according to the length (M) of a CZ sequence and the length (10) of an orthogonal cover sequence. In other words, the total number of identifiable UL BSRs is 10M.

Also, the length of a CZ sequence can be determined by N so that an N symbol BSR message can generate 12 symbols for each subframe.

At this time, the N symbols represent complex valued symbols generated through BPSK or QPSK modulation.

For example, in case N is 3, the length of a CZ sequence becomes 4, and the total number of UL BSRs identified by the CZ sequence can be 40 (4*10).

In case N is 6, the length of a CZ sequence becomes 2, and the total number of identifiable UL BSR messages becomes 20.

In case N is 12, a CZ sequence is not applied, but a total of 10 UL BSR messages can be identified through an orthogonal cover sequence of length 10.

In another embodiment, by redefining the PUCCH format 3 described above, namely, by using the PUCCH structure as described with reference to FIGS. 22 to 37, an N symbol BSR message can be used for identifying a plurality of UL BSR messages.

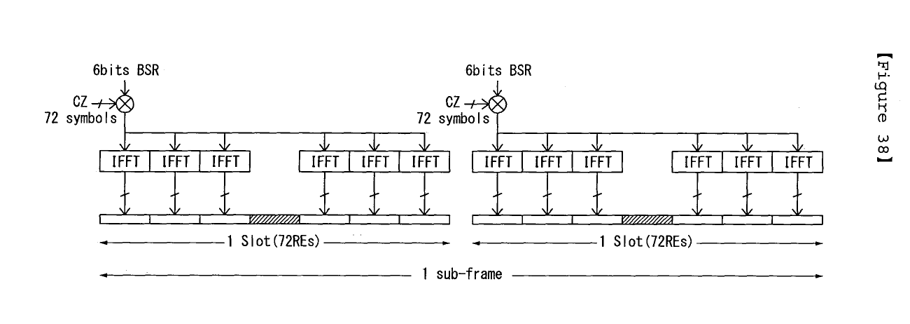

Next, a method for defining a new PUCCH format, namely, PUCCH format 4 without employing the existing PUCCH format intended for transmission of UL BSR messages will be described in detail with reference to FIGS. 38 to 51.

The new PUCCH format 4 described below defines one of 7 symbols within a slot as an RS and is capable of transmitting 6 symbols through a CZ sequence and an orthogonal cover (OC) sequence, namely, UL information (for example, an UL BSR message) through 72 REs.

First, FIGS. 38 to 40 illustrate examples of a PUCCH structure for identifying a plurality of UL BSR messages through a CZ sequence only without using an orthogonal cover sequence.

In other words, FIGS. 38 to 40 illustrate examples of a PUCCH format (or structure) for distinguishing a total of M UL BSR messages by multi-spreading of an N symbol BSR message into the frequency domain through a CZ sequence of length M within one subframe.

FIG. 38 illustrates another example of an uplink physical control channel format according to the present invention.

FIG. 38 shows a PUCCH format meant for transmitting an N symbol BSR message repeatedly from each of two slots.

With reference to FIG. 38, an N symbol BSR message generates 72 symbols for each slot through a CZ sequence of length M, and the 72 symbols are mapped to (or carried by) 5 symbols except for one central RS symbol through 6 IFFT modules so that the 72 symbols can be mapped to 72 REs for each slot.

At this time, a symbol within a slot or a subframe can be expressed by an SC-FDMA symbol.

In this case, the number of identifiable UL BSR messages can be determined by the length (M) of a CZ sequence. Therefore, a total number of identifiable UL BSR messages becomes M.

Also, the length of a CZ sequence can be determined by N so that an N symbol BSR message can generate 12 symbols within one slot.

At this time, the N symbols represent complex valued symbols generated through BPSK or QPSK modulation.

For example, in case N is 3, the length of a CZ sequence is 24, and a total number of UL BSR messages that can be identified through the CZ sequence becomes 24.

In case N is 6, the length of a CZ sequence is 12, and a total number of_{—} identifiable UL BSR messages can be 12.

In case N is 12, the length of a CZ sequence is 6, and a total number of identifiable UL BSR messages can be 6.

In case N is 72, a CZ sequence is not applied; thus only one UL BSR message can be identified.

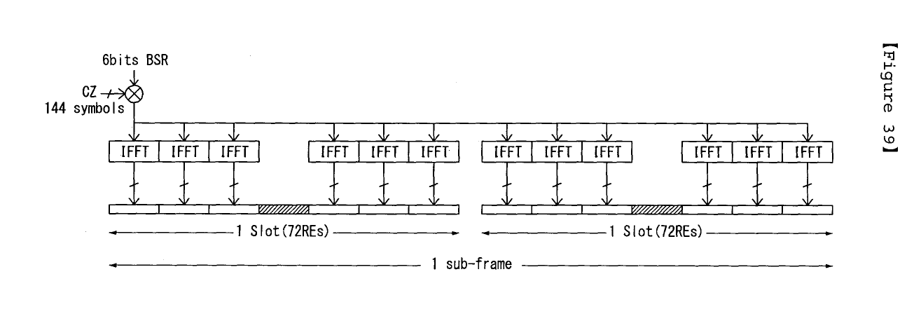

FIG. 39 illustrates another example of an uplink physical control channel format according to the present invention.

FIG. 39 illustrates a PUCCH format meant for transmitting an N symbol BSR message through one subframe only for once.

With reference to FIG. 39, for each subframe, an N symbol BSR message generates 144 symbols through a CZ sequence of length M, and the 144 symbols are mapped to (or carried by) 12 symbols except for 2 RS symbols (6 symbols excluding one RS symbol for each slot) through 12 IFFT modules (6 IFFT modules for each slot) so that the 144 symbols can be mapped to 144 REs (72 REs for each slot).

At this time, the number of identifiable UL BSR messages can be determined according to the length (M) of a CZ sequence.

In other words, the total number of identifiable UL BSRs is M.

Also, the length of a CZ sequence can be determined by N so that an N symbol BSR message can generate 144 symbols for each subframe.

At this time, the N symbols represent complex valued symbols generated through BPSK or QPSK modulation.

For example, in case N is 3, the length of a CZ sequence becomes 48, and the total number of UL BSRs identified by the CZ sequence can be 48.

In case N is 6, the length of a CZ sequence becomes 24, and the total number of identifiable UL BSR messages becomes 24.

In case N is 144, a CZ sequence is not applied; thus only one UL BSR message can be identified.

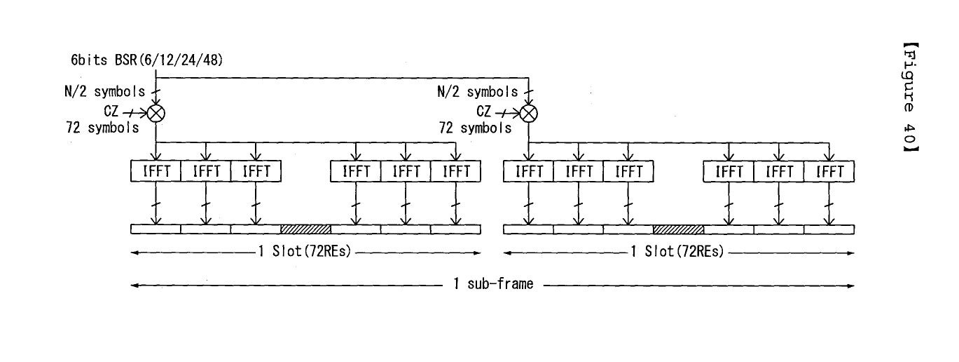

FIG. 40 illustrates another example of the uplink physical control channel format according to the present invention.

FIG. 40 illustrates a PUCCH format meant for transmitting an N symbol BSR message through one subframe only for once.

With reference to FIG. 40, one half (N/2 symbols) of an N symbol BSR message are input to each slot.

In other words, an N/2 symbol BSR message generates 72 symbols for each slot through a CZ sequence of length M, and the 72 symbols are mapped to (or carried by) 6 symbols except for one RS symbol through 6 IFFT modules so that the 72 symbols can be mapped to 72 REs for each slot.

As shown in FIG. 40, a signal output from each IFFT module is mapped to the corresponding symbol within a slot.

In this case, the number of identifiable UL BSR messages can be determined by the length (M) of a CZ sequence.

In other words, a total number of identifiable UL BSR messages becomes M.

Also, the length of a CZ sequence can be determined by N/2 so that an N/2 symbol BSR message can generate 72 symbols for each slot.

For example, in case N is 6, the length of a CZ sequence becomes 24, and a total number of UL BSR messages that can be identified through one subframe can be 24.

In case N is 12, the length of a CZ sequence becomes 12, and a total number of UL BSR messages that can be identified through one subframe can be 12.

In case N is 144, a CZ sequence is not applied; thus only one UL BSR message can be identified.

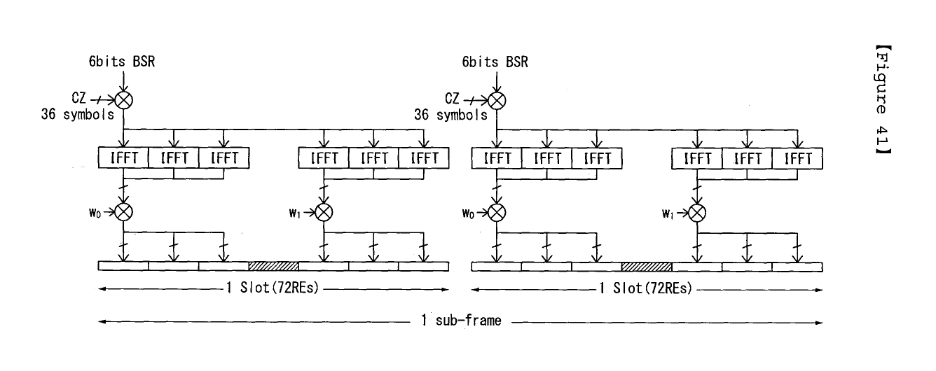

FIGS. 41 to 43 illustrate examples of a PUCCH structure for identifying a plurality of UL BSR messages by using an orthogonal cover sequence of length 2.

In other words, FIGS. 41 to 43 illustrate examples of a PUCCH format (or structure) for distinguishing a total of M*2 UL BSR messages by multi-spreading of an N symbol BSR message into the frequency domain and/or time domain through a CZ sequence of length M and/or an orthogonal cover sequence of length 2 within one subframe.

FIG. 41 illustrates another example of an uplink physical control channel format according to the present invention.

FIG. 41 shows a PUCCH format meant for transmitting an N symbol BSR message repeatedly from each of two slots.

With reference to FIG. 41, an N symbol BSR message generates 36 symbols for each slot through a CZ sequence of length M, and the 36 symbols are mapped to (or carried by) 6 symbols except for one central RS symbol through 6 IFFT modules so that the 36 symbols can be mapped to 72 REs for each slot.

At this time, a symbol within a slot or a subframe can be expressed by an SC-FDMA symbol.

In this case, the number of identifiable UL BSR messages can be determined by the length (M) of a CZ sequence and the length (2) of an orthogonal cover sequence. Therefore, a total number of identifiable UL BSR messages becomes 2M.

Also, the length of a CZ sequence can be determined by N so that an N symbol BSR message can generate 36 symbols within one slot.

At this time, the N symbols represent complex valued symbols generated through BPSK or QPSK modulation.

For example, in case N is 3, the length of a CZ sequence is 12, and a total number of UL BSR messages that can be identified through the CZ sequence becomes 24 (12*2).

In case N is 6, the length of a CZ sequence is 12, and a total number of identifiable UL BSR messages can be 12.

In case N is 36, a CZ sequence is not applied; thus a total of 2 UL BSR messages can be identified through an orthogonal cover sequence of length 2.

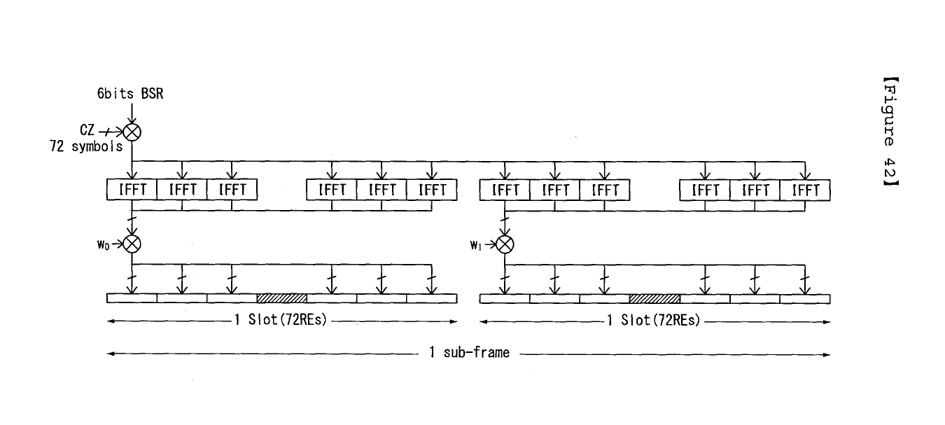

FIG. 42 illustrates another example of an uplink physical control channel format according to the present invention.

FIG. 42 illustrates a PUCCH format meant for transmitting an N symbol BSR message through one subframe only for once.

With reference to FIG. 42, for each subframe, an N symbol BSR message generates 72 symbols through a CZ sequence of length M, and the 72 symbols are mapped to (or carried by) 12 symbols except for 2 RS symbols (6 symbols excluding one RS symbol for each slot) through 12 IFFT modules (6 IFFT modules for each slot) so that the 72 symbols can be mapped to 144 REs (72 REs for each slot).

At this time, the number of identifiable UL BSR messages can be determined according to the length (M) of a CZ sequence and the length (2) of an orthogonal cover sequence. In other words, the total number of identifiable UL BSRs is 2M.

Also, the length of a CZ sequence can be determined by N so that an N symbol BSR message can generate 72 symbols for each subframe.

At this time, the N symbols represent complex valued symbols generated through BPSK or QPSK modulation.

For example, in case N is 3, the length of a CZ sequence becomes 24, and the total number of UL BSRs identified by the CZ sequence can be 48 (24*2).

In case N is 6, the length of a CZ sequence becomes 12, and the total number of identifiable UL BSR messages becomes 24.

In case N is 72, a CZ sequence is not applied; thus a total of 2 UL BSR messages can be identified through an orthogonal cover sequence of length 2.

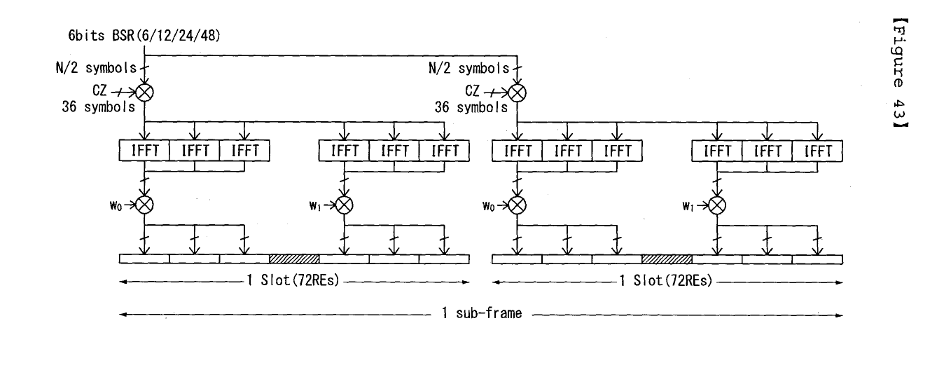

FIG. 43 illustrates another example of the uplink physical control channel format according to the present invention.

FIG. 43 illustrates a PUCCH format meant for transmitting an N symbol BSR message through one subframe only for once.

With reference to FIG. 43, one half (N/2 symbols) of an N symbol BSR message are input to each slot.

In other words, an N/2 symbol BSR message generates 36 symbols for each slot through a CZ sequence of length M, and the 36 symbols are mapped to (or carried by) 6 symbols except for one RS symbol through 6 IFFT modules so that the 36 symbols can be mapped to 72 REs for each slot.

The number of identifiable UL BSR messages can be determined by the length (M) of a CZ sequence and the length (2) of an orthogonal cover sequence. In other words, a total number of identifiable UL BSR messages becomes 2M.

Also, the length of a CZ sequence can be determined by N/2 so that an N/2 symbol BSR message can generate 36 symbols for each slot.

For example, in case N is 6, the length of a CZ sequence becomes 6, and a total number of UL BSR messages that can be identified through one subframe can be 12 (6*2).

In case N is 12, the length of a CZ sequence becomes 3, and a total number of UL BSR messages that can be identified through one subframe can be 6.

In case N is 36, a CZ sequence is not applied; thus a total of 2 UL BSR messages can be identified through an orthogonal cover sequence of length 2.

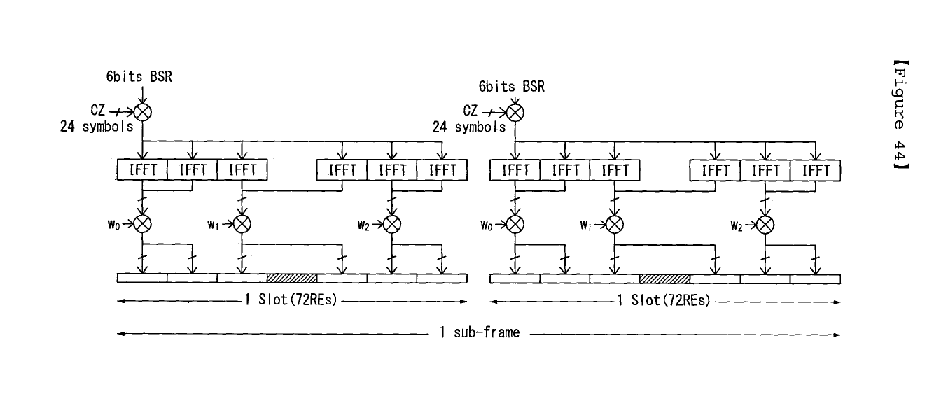

FIGS. 44 to 46 illustrate examples of a PUCCH structure for identifying a plurality of UL BSR messages by using an orthogonal cover sequence of length 3.

In other words, FIGS. 44 to 46 illustrate examples of a PUCCH format (or structure) for distinguishing a total of M*3 UL BSR messages by multi-spreading of an N symbol BSR message into the frequency domain and/or time domain through a CZ sequence of length M and/or an orthogonal cover sequence of length 3 within one subframe.

FIG. 44 illustrates another example of an uplink physical control channel format according to the present invention.

FIG. 44 shows a PUCCH format meant for transmitting an N symbol BSR message repeatedly from each of two slots.

With reference to FIG. 44, an N symbol BSR message generates 24 symbols for each slot through a CZ sequence of length M, and the 24 symbols are mapped to (or carried by) 6 symbols except for one central RS symbol through 6 IFFT modules so that the 24 symbols can be mapped to 72 REs for each slot.

At this time, a symbol within a slot or a subframe can be expressed by an SC-FDMA symbol.

At this time, the number of identifiable UL BSR messages can be determined by the length (M) of a CZ sequence and the length (3) of an orthogonal cover sequence. In other words, a total number of identifiable UL BSR messages becomes 3M.

Also, the length of a CZ sequence can be determined by N so that an N symbol BSR message can generate 24 symbols within one slot.

At this time, the N symbols represent complex valued symbols generated through BPSK or QPSK modulation.

For example, in case N is 3, the length of a CZ sequence is 8, and a total number of UL BSR messages that can be identified through the CZ sequence becomes 24 (8*3).

In case N is 6, the length of a CZ sequence is 4, and a total number of identifiable UL BSR messages can be 12.

In case N is 24, a CZ sequence is not applied, but a total of 3 UL BSR messages can be identified through an orthogonal cover sequence of length 3.

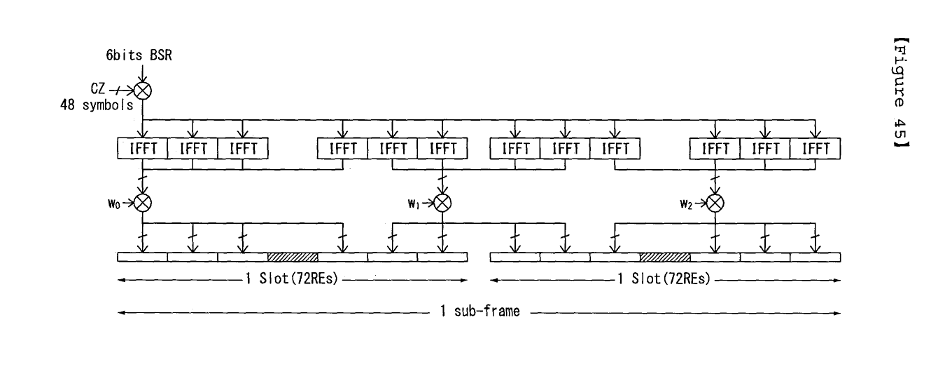

FIG. 45 illustrates another example of an uplink physical control channel format according to the present invention.

FIG. 45 illustrates a PUCCH format meant for transmitting an N symbol BSR message through one subframe only for once.

With reference to FIG. 45, for each subframe, an N symbol BSR message generates 48 symbols through a CZ sequence of length M, and the 48 symbols are mapped to (or carried by) 12 symbols except for 2 RS symbols (6 symbols excluding one RS symbol for each slot) through 12 IFFT modules (6 IFFT modules for each slot) so that the 48 symbols can be mapped to 144 REs (72 REs for each slot).

In the same way, the number of identifiable UL BSR messages can be determined according to the length (M) of a CZ sequence and the length (3) of an orthogonal cover sequence. In other words, the total number of identifiable UL BSRs is 3M.

Also, the length of a CZ sequence can be determined by N so that an N symbol BSR message can generate 48 symbols for each subframe.

At this time, the N symbols represent complex valued symbols generated through BPSK or QPSK modulation.

For example, in case N is 3, the length of a CZ sequence becomes 16, and the total number of UL BSRs identified by the CZ sequence can be 48 (16*3).

In case N is 6, the length of a CZ sequence becomes 16, and the total number of identifiable UL BSR messages becomes 24.

In case N is 48, a CZ sequence is not applied, but a total of 3 UL BSR messages can be identified through an orthogonal cover sequence of length 3.

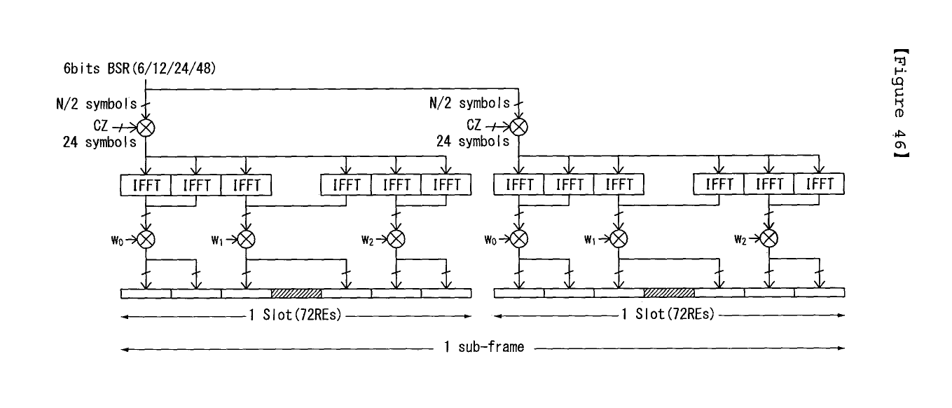

FIG. 46 illustrates another example of the uplink physical control channel format according to the present invention.

FIG. 46 illustrates a PUCCH format meant for transmitting an N symbol BSR message through one subframe only for once.

With reference to FIG. 46, one half (N/2 symbols) of an N symbol BSR message are input to each slot.

In other words, an N/2 symbol BSR message generates 24 symbols for each slot through a CZ sequence of length M, and the 24 symbols are mapped to (or carried by) 6 symbols except for one RS symbol through 6 IFFT modules so that the 24 symbols can be mapped to 72 REs for each slot.

In this case, the number of identifiable UL BSR messages can be determined by the length (M) of a CZ sequence and the length (3) of an orthogonal cover sequence. In other words, a total number of identifiable UL BSR messages becomes 3M.

Also, the length of a CZ sequence can be determined by N/2 so that an N/2 symbol BSR message can generate 24 symbols for each slot.

For example, in case N is 6, the length of a CZ sequence becomes 8, and a total number of UL BSR messages that can be identified through one subframe can be 24 (8*3).

In case N is 12, the length of a CZ sequence becomes 4, and a total number of UL BSR messages that can be identified through one subframe can be 12.

In case N is 48, a CZ sequence is not applied, but a total of 3 UL BSR messages can be identified through an orthogonal cover sequence of length 3.

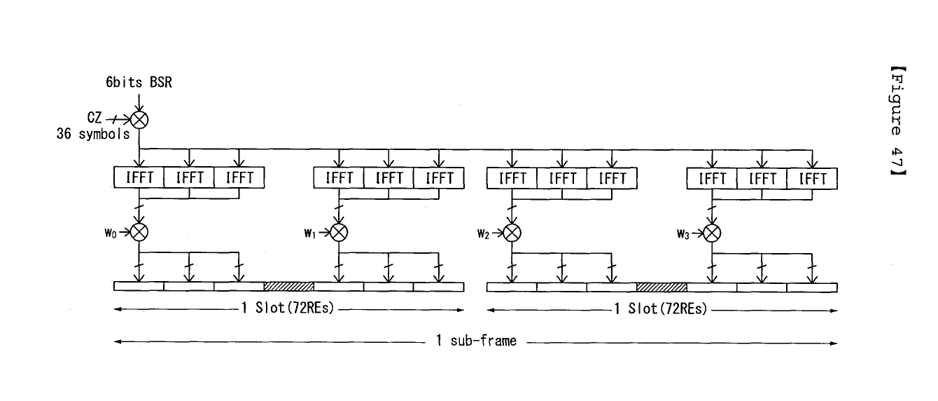

FIG. 47 illustrates another example of an uplink physical control channel format according to the present invention.

FIG. 47 illustrates an example of a PUCCH structure for identifying a plurality of UL BSR messages by using an orthogonal cover sequence of length 4.

In other words, FIG. 47 illustrates one example of a PUCCH format (or structure) for distinguishing a total of M*4 UL BSR messages by multi-spreading of an N symbol BSR message into the frequency domain and/or time domain through a CZ sequence of length M and/or an orthogonal cover sequence of length 4 within one subframe.

FIG. 47 illustrates a PUCCH format meant for transmitting an N symbol BSR message through one subframe only for once.

With reference to FIG. 47, for each subframe, an N symbol BSR message generates 36 symbols through a CZ sequence of length M, and the 36 symbols are mapped to (or carried by) 12 symbols except for 2 RS symbols (6 symbols excluding one RS symbol for each slot) through 12 IFFT modules (6 IFFT modules for each slot) so that the 36 symbols can be mapped to 144 REs (72 REs for each slot).

At this time, the number of identifiable UL BSR messages can be determined according to the length (M) of a CZ sequence and the length (4) of an orthogonal cover sequence. In other words, the total number of identifiable UL BSRs is 4M.

Also, the length of a CZ sequence can be determined by N so that an N symbol BSR message can generate 36 symbols for each subframe.

At this time, the N symbols represent complex valued symbols generated through BPSK or QPSK modulation.

For example, in case N is 3, the length of a CZ sequence becomes 12, and the total number of UL BSRs identified by the CZ sequence can be 48 (12*4).

In case N is 6, the length of a CZ sequence becomes 6, and the total number of identifiable UL BSR messages becomes 24.

In case N is 36, a CZ sequence is not applied, but a total of 4 UL BSR messages can be identified through an orthogonal cover sequence of length 4.

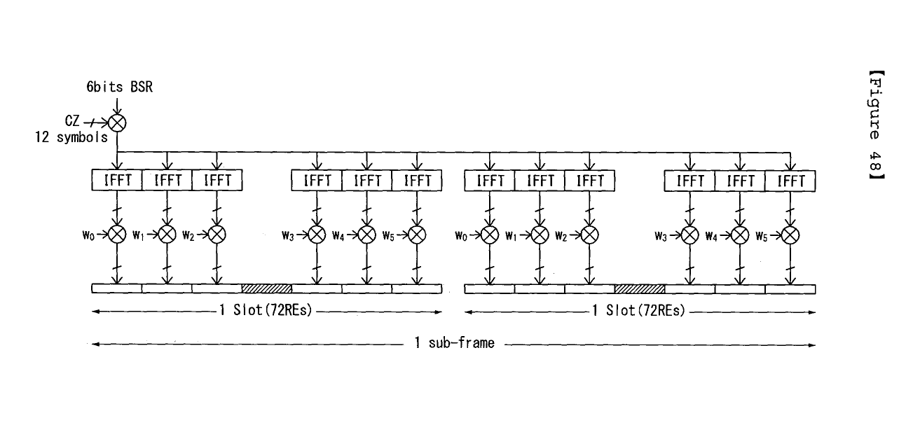

FIGS. 48 to 50 illustrate examples of a PUCCH structure for identifying a plurality of UL BSR messages by using an orthogonal cover sequence of length 6.

In other words, FIGS. 48 to 50 illustrate examples of a PUCCH format (or structure) for distinguishing a total of M*6 UL BSR messages by multi-spreading of an N symbol BSR message into the frequency domain and/or time domain through a CZ sequence of length M and/or an orthogonal cover sequence of length 6 within one subframe.

FIG. 48 illustrates another example of an uplink physical control channel format according to the present invention.

FIG. 48 shows a PUCCH format meant for transmitting an N symbol BSR message repeatedly from each of two slots.

With reference to FIG. 48, an N symbol BSR message generates 12 symbols for each slot through a CZ sequence of length M, and the 12 symbols are mapped to (or carried by) 6 symbols except for one central RS symbol through 6 IFFT modules so that the 12 symbols can be mapped to 72 REs for each slot.

At this time, a symbol within a slot or a subframe can be expressed by an SC-FDMA symbol.

At this time, the number of identifiable UL BSR messages can be determined by the length (M) of a CZ sequence and the length (6) of an orthogonal cover sequence. In other words, a total number of identifiable UL BSR messages becomes 6M.

Also, the length of a CZ sequence can be determined by N so that an N symbol BSR message can generate 12 symbols within one slot.

At this time, the N symbols represent complex valued symbols generated through BPSK or QPSK modulation.

For example, in case N is 3, the length of a CZ sequence is 4, and a total number of UL BSR messages that can be identified through the CZ sequence becomes 24 (4*6).

In case N is 6, the length of a CZ sequence is 2, and a total number of identifiable UL BSR messages can be 12.

In case N is 12, a CZ sequence is not applied, but a total of 6 UL BSR messages can be identified through an orthogonal cover sequence of length 6.

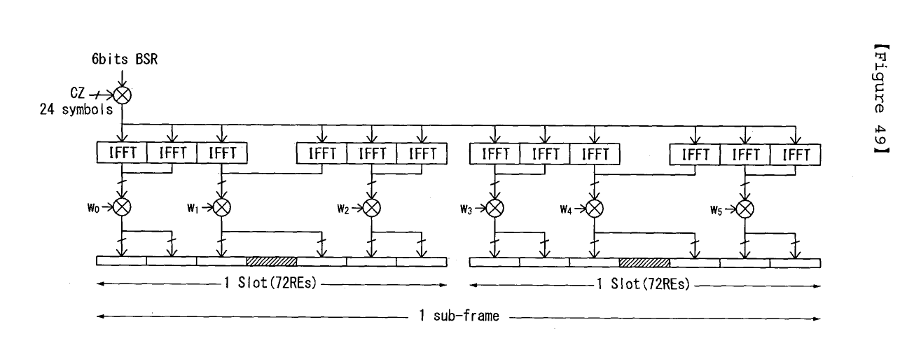

FIG. 49 illustrates another example of an uplink physical control channel format according to the present invention.

FIG. 49 illustrates a PUCCH format meant for transmitting an N symbol BSR message through one subframe only for once.

With reference to FIG. 49, for each subframe, an N symbol BSR message generates 24 symbols through a CZ sequence of length M, and the 24 symbols are mapped to (or carried by) 12 symbols except for 2 RS symbols (6 symbols excluding one RS symbol for each slot) through 12 IFFT modules (6 IFFT modules for each slot) so that the 24 symbols can be mapped to 144 REs (72 REs for each slot).

The number of identifiable UL BSR messages can be determined according to the length (M) of a CZ sequence and the length (6) of an orthogonal cover sequence. In other words, the total number of identifiable UL BSRs is 6M.

Also, the length of a CZ sequence can be determined by N so that an N symbol BSR message can generate 24 symbols for each subframe.

At this time, the N symbols represent complex valued symbols generated through BPSK or QPSK modulation.

For example, in case N is 3, the length of a CZ sequence becomes 8, and the total number of UL BSRs identified by the CZ sequence can be 48 (8*6).

In case N is 6, the length of a CZ sequence becomes 4, and the total number of identifiable UL BSR messages becomes 24.

In case N is 24, a CZ sequence is not applied, but a total of 6 UL BSR messages can be identified through an orthogonal cover sequence of length 6.

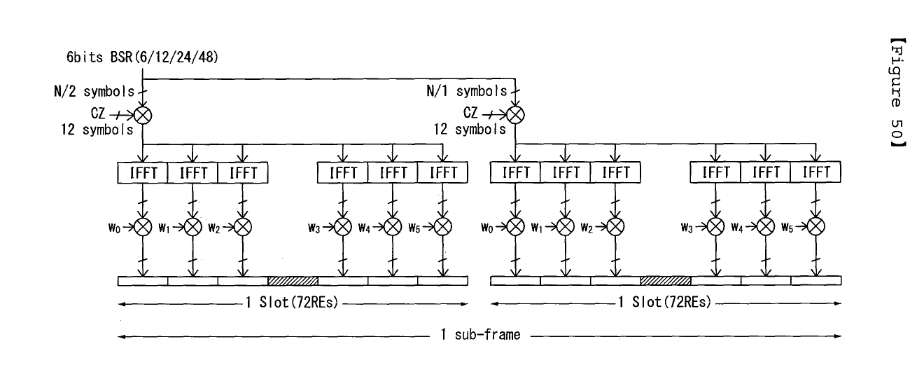

FIG. 50 illustrates another example of the uplink physical control channel format according to the present invention.

FIG. 50 illustrates a PUCCH format meant for transmitting an N symbol BSR message through one subframe only for once.

With reference to FIG. 50, one half (N/2 symbols) of an N symbol BSR message are input to each slot.

In other words, an N/2 symbol BSR message generates 12 symbols for each slot through a CZ sequence of length M, and the 12 symbols are mapped to (or carried by) 6 symbols except for one RS symbol through 6 IFFT modules so that the 12 symbols can be mapped to 72 REs for each slot.

In this case, the number of identifiable UL BSR messages can be determined by the length (M) of a CZ sequence and the length (6) of an orthogonal cover sequence. In other words, a total number of identifiable UL BSR messages becomes 6M.

Also, the length of a CZ sequence can be determined by N/2 so that an N/2 symbol BSR message can generate 12 symbols for each slot.

For example, in case N is 6, the length of a CZ sequence becomes 4, and a total number of UL BSR messages that can be identified through one subframe can be 24 (4*6).

In case N is 12, the length of a CZ sequence becomes 2, and a total number of UL BSR messages that can be identified through one subframe can be 12.

In case N is 24, a CZ sequence is not applied, but a total of 6 UL BSR messages can be identified through an orthogonal cover sequence of length 6.

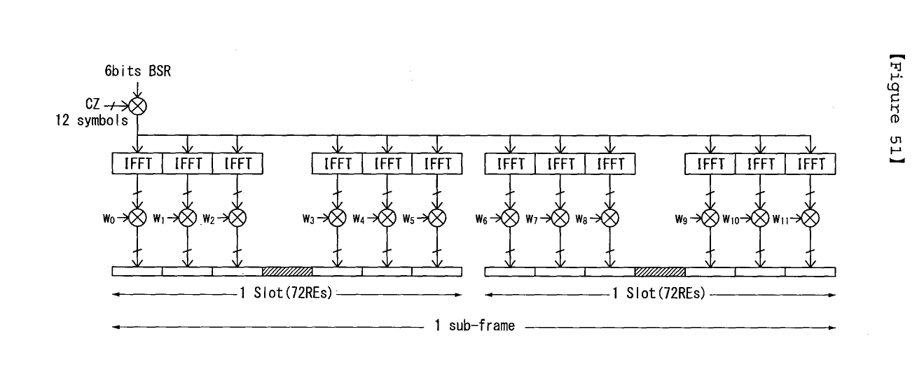

FIG. 51 illustrates another example of an uplink physical control channel format according to the present invention.

FIG. 51 illustrates an example of a PUCCH structure for identifying a plurality of UL BSR messages by using an orthogonal cover sequence of length 12.

In other words, FIG. 51 illustrates one example of a PUCCH format (or structure) for distinguishing a total of M*12 UL BSR messages by multi-spreading of an N symbol BSR message into the frequency domain and/or time domain through a CZ sequence of length M and/or an orthogonal cover sequence of length 12 within one subframe.

FIG. 51 illustrates a PUCCH format meant for transmitting an N symbol BSR message through one subframe only for once.

With reference to FIG. 51, for each subframe, an N symbol BSR message generates 36 symbols through a CZ sequence of length M, and the 12 symbols are mapped to (or carried by) 12 symbols except for 2 RS symbols (6 symbols excluding one RS symbol for each slot) through 12 IFFT modules (6 IFFT modules for each slot) so that the 12 symbols can be mapped to 144 REs (72 REs for each slot).

At this time, the number of identifiable UL BSR messages can be determined according to the length (M) of a CZ sequence and the length (12) of an orthogonal cover sequence. In other words, the total number of identifiable UL BSRs is 12M.

Also, the length of a CZ sequence can be determined by N so that an N symbol BSR message can generate 12 symbols for each subframe.

At this time, the N symbols represent complex valued symbols generated through BPSK or QPSK modulation.

For example, in case N is 3, the length of a CZ sequence becomes 4, and the total number of UL BSRs identified by the CZ sequence can be 48 (4*12).

In case N is 6, the length of a CZ sequence becomes 2, and the total number of identifiable UL BSR messages becomes 24.

In case N is 12, a CZ sequence is not applied, but a total of 12 UL BSR messages can be identified through an orthogonal cover sequence of length 12.

As described with reference to FIGS. 21 to 51, in case UL data (or UL control information) are transmitted by using the PUCCH format according to the present invention, a UE makes a transition from the DRX mode to the active mode, and the UE required to transmit the UL data is enabled to transmit the UL data even faster.

In other words, in the case of the UL data transmission method described with reference to FIG. 18, the UE notifies the eNB by using SR resources of a PUCCH about necessity of UL scheduling. The eNB, receiving the notification, may allocate UL data resources to the UE so that the UE can transmit a BSR message. In the case of the methods according to the present invention, however, the UE transmits a BSR message directly to the eNB by using BSR PUCCH resources already allocated to the UE when uplink data transmission is required. Therefore, the UE can receive an UL grant directly for the data that the UE attempts to actually transmit.

In other words, the present invention reduces a maximum of 8 ms delay, thereby enabling a UE to change to the active mode much faster and at the same time, to transmit uplink data quickly.

Overview of an Apparatus to Which the Present Invention Can Be Applied

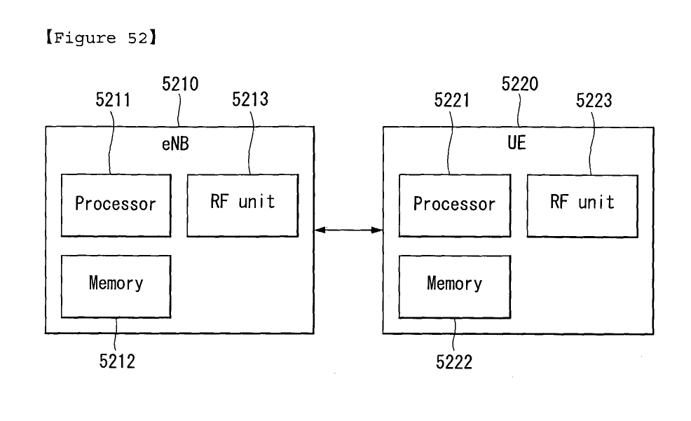

FIG. 52 illustrates a block diagram of a wireless communication device to which the present invention can be applied.

With reference to FIG. 52, a wireless communication system comprises an eNB S210 and a plurality of UEs S220 located within the coverage of the eNB S210.

An eNB S210 comprises a processor S211, a memory S212, and a radio frequency (RF) unit S213. The processor S211 implements a function, process and/or method propose through FIGS. 1 to 51. Layers of radio interface protocols can be implemented by the processor S211. The memory S212, being connected to the processor S211, stores various types of information to operate the processor S211. The RF unit S213, being connected to the processor S211, transmits and/or receives a radio signal.

A UE S220 comprises a processor S221, a memory S222, and a radio frequency (RF) unit S223. The processor S221 implements a function, process and/or method propose through FIGS. 1 to 51. Layers of radio interface protocols can be implemented by the processor S221. The memory S222, being connected to the processor S221, stores various types of information to operate the processor S221. The RF unit S223, being connected to the processor S221, transmits and/or receives a radio signal.

The memory S212, S222 can be located inside or outside the processor S211, S212 and can be connected to the processor S211, S221 through a well-known means.

The eNB S210 and/or the UE S220 can have a single antenna or multiple antennas.

The embodiments described above are a combination of constituting elements and features of the present invention in particular forms. Unless otherwise specified, each constituting element or feature should be regarded to be selective. Each constituting element or feature can be embodied solely without being combined with other constituting element or feature. It is also possible to construct embodiments of the present invention by combining part of constituting elements and/or features. The order of operations illustrated in the embodiments of the present invention can be changed. Part of a structure or feature of an embodiment can be included by another embodiment or replaced with the corresponding structure or feature of another embodiment. It should be clear that embodiments can also be constructed by combining those claims revealing no explicit reference relationship with one another, or the combination can be included as a new claim in a revised application of the present invention afterwards.

Embodiments according to the present invention can be realized by various means, for example, hardware, firmware, software, or a combination thereof. In the case of hardware implementation, the embodiments of the present invention can be implemented by one or more of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, and the like.

In the case of firmware or software implementation, methods according to the embodiment of the present invention can be implemented in the form of module, procedure, or function carrying out operations described above. Software codes can be stored in a memory unit and executed by a processor. The memory unit, being located inside or outside the processor, can communicate data with the processor through various means known in the fields of the art.

It should be clearly understood by those skilled in the art that the present invention can be realized in a different, particular form as long as the present invention retains the essential features of the present invention. Therefore, the detailed description above should not be interpreted limitedly from all aspects of the invention but should be regarded as an illustration. The technical scope of the invention should be determined through a reasonable interpretation of the appended claims; all the possible modifications of the present invention within an equivalent scope of the present invention should be understood to belong to the technical scope of the present invention.

### INDUSTRIAL APPLICABILITY

This document discloses a method for requesting scheduling for uplink data transmission in a wireless communication system with examples based on the 3GPP LTE/LTE-A system; however, the present invention can be applied to various other types of wireless communication systems in addition to the 3GPP LTE/LTE-A system.

1. A method for transmitting uplink (UL) data in a wireless communication system, the method performed by a UE comprising:
receiving physical uplink control channel (PUCCH) resources for transmitting a BSR(Buffer Status Report) from a base station;
transmitting the BSR to the base station through the allocated PUCCH resources;
receiving an UL grant for transmitting the UL data from the base station; and
transmitting the UL data to the base station through the received UL grant,
wherein a control information related to a structure of the PUCCH resources is received through allocation of the PUCCH resources.

2. The method of claim 1, wherein the control information includes at least one of a BSR PUCCH resource setup field, a BSR PUCCH resource release field, a BSR PUCCH resource index field representing the index of a BSR PUCCH resource, or a BSR LogicaiChIndex field representing a BSR PUCCH resource configuration field related to configuration of a BSR PUCCH resource or a logical channel index of the BSR PUCCH resource.

3. The method of claim 1, wherein the PUCCH resources are a structure where an N symbol BSR generated through BPSK (Binary Phase Shift Keying) or QPSK (Quadrature Phase Shift Keying) modulation is transmitted repeatedly through 2 slots of one subframe or transmitted only once through one subframe.

4. The method of claim 3, wherein the N symbol BSR is mapped to the PUCCH resources by:
being spread in the frequency domain through a CAZAC (CZ) sequence of length M and/or in the time domain through an orthogonal cover (OC) sequence of length L;
carrying out IFFT (Inverse Fast Fourier Transform); and
being mapped to remaining symbols except for a reference signal (RS) symbol within one slot or one subframe.

5. The method of claim 4, wherein the number of RS symbols is 3, 2, or 1 within one slot; and the number of remaining symbols is 4, 5, or 6 within one slot.

6. The method of claim 4, wherein the length (M) of a CZ sequence is determined according to the number (N) of symbols of a BSR generated through the BPSK or the QPSK modulation.

7. The method of claim 4, wherein the number of BSR that can be distinguished from each other through the PUCCH resources is determined by the CZ sequence of length M and/or the orthogonal cover sequence of length L.

8. The method of claim 7, wherein the number of BSR that can be distinguished from each other through the PUCCH resources is M*L.

9. The method of claim 3, wherein the N value is 3, 6, 12, 48, 96, 192, 36, 72, 144, or 288.

10. The method of claim 4, wherein the M value is 0, 2, 3, 4, 5, 6, 8, 10, 12, 16, 20, 24, 40 or 48.

11. The method of claim 4, wherein the L value is 0, 2, 3, 4, 5, 6, 8, or 10.

12. The method of claim 1, wherein the control information is transmitted through a cell entry process or an RRC (Radio Resource Control) connection reconfiguration process.

13. The method of claim 1, further comprising transmitting a scheduling request to the base station, where the SR is transmitted together with the BSR.

14. A UE for transmitting uplink data in a wireless communication system, comprising:
a radio frequency (RF) unit for transmitting and receiving a radio signal; and
a processor, wherein the processor is configured
to receive from a base station control information related to configuration of physical uplink control channel (PUCCH) resources for BSR transmission;
to transmit a BSR to the base station through the PUCCH resources based on the received control information;
to receive an UL grant for UL data transmission from the base station; and
to transmit UL data to the base station through the received UL grant.
